(19) United States
(12) Patent Application Publication
(10) Pub. No.: US 2003/0120566 A1
(43) Pub. Date: Jun. 26, 2003

(54) Interest determination system and method

(75) Inventors: Mark L. Lipschutz, Howard Beach, NY (US); Anthony F. Caggiano, Chatham, NJ (US)

Correspondence Address: PILLSBURY WINTHROP, LLP, P.O. BOX 10500, MCLEAN, VA, 22102, US

(73) Assignee: UBS PaineWebber Inc., Weehawken, NJ

(21) Appl. No.: 10/022,510

(22) Filed: Dec. 20, 2001

(51) Int. Cl. G06F 17/60

(52) U.S. Cl. 705/30; 705/36

(57) ABSTRACT

In accordance with at least one embodiment of the invention, an interest determination system is provided that may perform daily calculation of account interest, with a single monthly processing of associated charges to clients.

### BACKGROUND OF THE INVENTION

1. Field of the Invention

The present invention relates to calculating interest on debits and credits and associated fees and costs.

2. Description of Related Art

Conventional computerized interest calculation systems were first developed more than twenty-five years ago. Since then there have been many modifications and enhancements, including the ability to calculate a blended interest rate (e.g., an internally administered rate, for margin loans from which the organization administering the interest determination system may mark up or down), access or view data pertaining to related accounts (e.g., accounts associated with a particular account by, for example, familial or business relationships), use of money market netting (e.g., taking into account all of an account owner's assets to determine the outstanding balance for calculating interest amounts), determining credit interest on cash loan balances, and most recently the ability to perform Late Payment Interest (LPI) calculations.

Conventionally, rates are based upon a base lending rate. The base lending rate, the cost of money interest rate (e.g., a daily interest rate that reflects the Treasury Funding desk's average cost to fund operations), and the credit interest rate may be entered into the system through an interest determination system rates screen such as the one shown in FIG. 1.

Clients receiving preferred interest rates are conventionally entered by branch administration personnel through an interest rates change screen such as that illustrated in FIG. 2. The data is then stored in a master interest database. Accounts may be coded to be exempt from interest through an interest rates change screen as well.

Clients having related accounts are conventionally entered by branch administration personnel through an interest related accounts screen such as that illustrated in FIG. 3. The relationships between the accounts are then stored in a file accessed by the interest determination system.

It is also well known, under certain circumstances, to charge interest rates that are plus or minus a specific percentage from the base lending rate. Cancellation of interest charges or adjustments to interest charges may be made through an interest determination system detail screen such as the one illustrated in FIG. 4. Total charges and adjustments to interest may be displayed at various levels. For example, if margin interest (e.g., the interest associated with clients borrowing money from a brokerage organization) were being calculated, total charge and adjustments to interest may be displayed per broker, per branch, etc., and may be viewed on a totals screen, such as the one illustrated in FIG. 5.

Nevertheless, such conventional systems may not allow for necessary flexibility to ensure that interest is being calculated as accurately as possible. Much of the software supporting, implementing or included in conventional interest calculation systems is written in code that is difficult to maintain, e.g., Assembler or COBOL1. These systems do not allow for the flexibility of multiple interest rate structures; additionally, there is no historical data within the systems and no “as of” processing of technical shorts (e.g., when a security is sold in a cash account and the physical shares are not there; for example, a customer sells a security and this customer's physical security certificate is in the mail to be sent to his or her broker).

Conventional interest calculation systems often close interest calculation periods on, for example, the twenty first of each month, or the business day prior, if that day is a non-business day, (e.g., weekend or holiday), except December when it is the 31^{st} or the last business day of the fiscal year. Moreover, there is no ability to perform “out of cycle” closes (e.g., charging a client interest for a prior calendar month as opposed to a current cycle of the 22^{nd} of the prior month to the 21^{st} of the current month).

### SUMMARY OF THE INVENTION

In accordance with at least one embodiment of the invention, an interest determination system is provided that may perform daily calculation of interest, with a single monthly processing of associated charges to clients.

### BRIEF DESCRIPTION OF THE DRAWINGS

FIG. 1 illustrates an example of a conventional interest determination system rates screen;

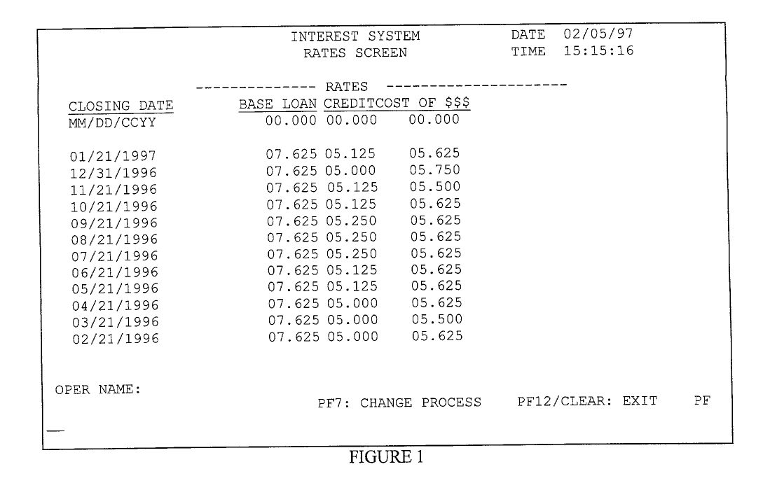

FIG. 2 illustrates an example of a conventional interest rates change screen;

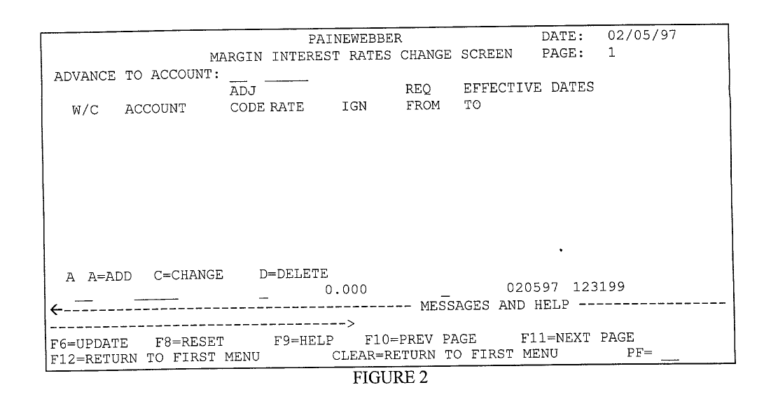

FIG. 3 illustrates an example of a conventional interest related accounts screen;

FIG. 4 illustrates an example of a conventional interest determination system detail screen;

FIG. 5 illustrates an example of a conventional total charges and adjustments screen;

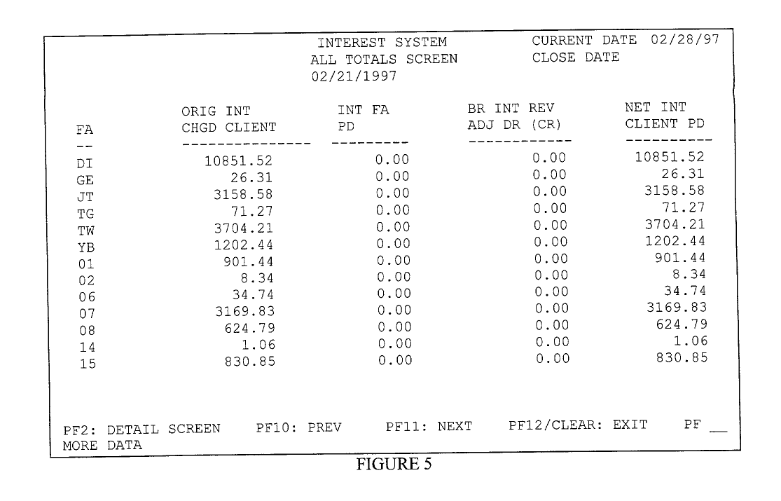

FIG. 6 illustrates an example of a functional architecture used to implement an interest rate determination system designed in accordance with at least one embodiment of the invention;

FIG. 7 illustrates an example of a “Reference Interest Rate” screen implemented in accordance with at least one embodiment of the invention;

FIG. 8 illustrates an example of an “Interest Rate Calendar” screen implemented in accordance with at least one embodiment of the invention;

FIG. 9 illustrates an example of a “Main Menu” screen implemented in accordance with at least one embodiment of the invention;

FIG. 10 illustrates an example of a “Daily Billing History” screen implemented in accordance with at least one embodiment of the invention;

FIG. 11 illustrates an example of a “Monthly Billing History” screen implemented in accordance with at least one embodiment of the invention;

FIG. 12 illustrates an example of a “Debit Account Information” screen implemented in accordance with at least one embodiment of the invention;

FIG. 13 illustrates an example of a “Sign On” screen implemented in accordance with at least one embodiment of the invention;

FIG. 14 illustrates an example of a “Grid Structure” screen implemented in accordance with at least one embodiment of the invention;

FIG. 15 illustrates an example of a “Broker Compensation” screen implemented in accordance with at least one embodiment of the invention;

FIG. 16 illustrates an example of an “Administrative Functions Menu” screen implemented in accordance with at least one embodiment of the invention;

FIG. 17 illustrates an example of a “Family of Related Accounts” screen implemented in accordance with at least one embodiment of the invention;

FIG. 18 illustrates an example of a “Grid/Reference Interest Rate Assignment” screen implemented in accordance with at least one embodiment of the invention;

FIG. 19 illustrates an example of a “Loan Reports By Type” screen implemented in accordance with at least one embodiment of the invention;

FIG. 20 illustrates an example of a “Loan Reports By Account” screen implemented in accordance with at least one embodiment of the invention;

FIG. 21 illustrates an example of a “Loan Reports By Wire Code For a Type” screen implemented in accordance with at least one embodiment of the invention;

FIG. 22 illustrates an example of a “Preferred Interest Rate” screen implemented in accordance with at least one embodiment of the invention;

FIG. 23 illustrates an example of an “Approve Preferred Interest Rates” screen implemented in accordance with at least one embodiment of the invention;

FIG. 24 illustrates an example of an “Administration-Global/Custom Features” screen implemented in accordance with at least one embodiment of the invention;

FIG. 25 illustrates an example of a “Reasons for Disapproval” screen implemented in accordance with at least one embodiment of the invention;

FIG. 26 illustrates an example of a “Rate Approval History” screen implemented in accordance with at least one embodiment of the invention;

FIG. 27 illustrates an example of an “Interest Calculation Change” screen implemented in accordance with at least one embodiment of the invention;

FIG. 28 illustrates an example of a “Loan Approval” screen implemented in accordance with at least one embodiment of the invention;

FIG. 29 illustrates an example of “List of Families of Related Accounts” screen implemented in accordance with at least one embodiment of the invention;

FIG. 30 illustrates an example of a “State Usury Interest Rate Maintenance” screen implemented in accordance with at least one embodiment of the invention;

FIG. 31 illustrates an example of a “Credit Account Information” screen implemented in accordance with at least one embodiment of the invention;

FIG. 32 illustrates an example of a “Daily Interest Rebate History” screen implemented in accordance with at least one embodiment of the invention;

FIG. 33 illustrates an example of a “Monthly Interest Rebate History” screen implemented in accordance with at least one embodiment of the invention;

FIG. 34 illustrates an example of a “Credit Reports By Type” screen implemented in accordance with at least one embodiment of the invention;

FIG. 35 illustrates an example of a “Credit Reports By Account” screen implemented in accordance with at least one embodiment of the invention;

FIG. 36 illustrates an example of a “Credit Reports By Wire Code for a Type” screen implemented in accordance with at least one embodiment of the invention; and

FIG. 37 illustrates an example of a “Set Type 1 Rebate” screen implemented in accordance with at least one embodiment of the invention.

### DETAILED DESCRIPTION OF EMBODIMENT OF THE INVENTION

At least one embodiment of the invention provides an interest determination system that has particular utility in calculating interest associated with margins, or money that a client borrows from their broker to buy financial instruments, e.g., stocks. A margin is a loan secured by collateral in the existing marginable securities in the client's account. How much the client can borrow is determined by how much value is in the client's account.

Margin is like a credit line issued to the client by the broker. The interest rates charged for margin are often lower than the rates the client pays to a credit card company. Margin interest rates may be decreased as the client borrows more money; this is often implemented by the broker providing a preferred interest rate to the client based on the amount borrowed and/or paid back.

The Federal Reserve Board regulates the amount of credit brokerages are allowed to extend to their clients. However, the amount a client can borrow is not a fixed number. Rather, margin is tied to the value of the marginable securities in the client's portfolio. Therefore, buying power changes daily, along with the changes in the client's stocks' prices. If the portfolio goes up, the amount the client can borrow increases. Along with the volatility in available credit limits, the margin interest rates change along with various reference interest rates upon which they are based. However, because of the dynamic nature of the stock market, accurately determining an appropriate interest rate and interest on an outstanding debit or credit is important.

Accordingly, in accordance with the embodiments of the invention, daily calculation of interest with single, monthly processing of client charges is more precise than conventional calculations thereof which involves merely multiplying the average monthly blended interest rate by the average monthly balance. There may be a choice of reference interest rates, instead of the restrictions in conventional system with the inflexibility in utilizing rates other than the base rate. Choices may include, for example, prime interest rate (e.g., the interest rate at which a bank will lend to its most creditworthy customers; an administered interest rate that may change infrequently), broker call interest rate (e.g., the interest rate that banks will lend to broker/dealers using the securities positions of their clients as collateral; an administered interest rate that changes in a similar fashion with the prime rate), base lending interest rate (e.g., an internal rate used to charge clients to borrow), LIBOR-30 day interest rate and LIBOR-60 day interest rate (LIBOR is the London Interbank Offered Rate, which is charged by international banks to their most creditworthy international bank customers in the eurodollar market; this interest rate customarily is quoted as a short term rate) among others. Interest rates may be determined to the nearest thousandth rather than eighths as is done conventionally.

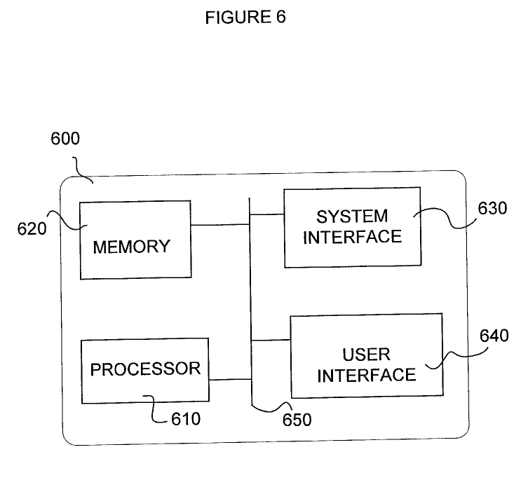

FIG. 6 illustrates one example of a functional architecture used to implement an interest rate determination system designed in accordance with at least one embodiment of the invention. As illustrated in FIG. 6, the system 600 may include at least one processor 610, at least one memory device or area 620, at least one system interface 630, at least one user interface 640 and a communication/data/control bus 650 that couples elements 610-640 together and allows for cooperation and communication between those elements.

The memory 620 may be implemented utilizing alternative configurations depending on the needs of a user or a system associated with the interest determination system. The system interface 630 may include both hardware and software to allow the system 600 to communicate with components that provide data utilized by the interest determination system, for example, data feeds providing financial data, account data, reference rate data, etc., or utilize data provided by the interest determination system. For example, users can enter a preferred rate (through user interface 600) for a range of accounts through this Margin Billing System Preference Rate screen. System interface (630) may then receive the user input and store the information in relevant databases.

The processor 610 may control operation of the other elements 620-650, based on instructions fetched from the memory 620. The instructions may include or be implemented as software code that dictates some or all of the operations of the interest determination system. The memory 620 may include this code and may also include storage area for data utilized by or generated by the interest determination system. The processor 610 may fetch the instructions, decode them, and act or instruct other elements 620-650 to, for example, transfer data to or from the memory 620 or to work in combination with the system interface 630 or the user interface 640 (for example, to input or output data), etc.

The processor 610 may actually be implemented as part of one or more than one processor. The processor 610 may, based on instructions fetched from the memory 620, operate to control operation of the other elements 620-650. It should be appreciated that the processor 610 may be implemented, for example, in a central processing unit, or other similar device. Similarly, the some part or all of the functionality of the processor 610 and the memory 620 may be implemented via one or more servers coupled to a network that allows the one or more user interfaces 640 to be implemented at a user terminal and include one or more Graphical User Interfaces (GUIs) on a display screen.

The at least one user interface 640 may include, for example, hardware and software for cooperating with a terminal display, a keyboard and mouse, etc. Moreover, the user interface 640 may include a speaker and microphone, not shown, for outputting and inputting data to and from a user. The user interface 640 may operate in conjunction with the processor 610 to allow a user to interact with software programs stored in the memory 620 and used by the processor 610 so as to perform the operations explained below.

The interest determination system can be implemented, for example, as portions of a suitably programmed general-purpose computer. It should be appreciated that the particular form of the system can be different from that explained herein. For example, although the interest determination system has been described as being implementable on a specific computer, it is foreseeable that the system may be implemented in whole or in part in a network environment wherein software implementing the system functionality is stored on one or more servers and terminals, which access or utilize the system via the server(s).

In accordance with at least one embodiment of the invention, pending month-to-date charge and rebate calculations may be displayed if requested, via the user interface 640 provided by the interest determination system. Pending charges may also be displayed on a value screen indicating values of assets associated with an account inquiry system or module.

In accordance with at least one embodiment of the invention, a user interface includes a screen with interest data as of the previous night.

As a result of implementing the interest rate determination system, interest rate customization may be more flexible and easier to administer. The details of each charge may be maintained within the system, with extensive details on the calculation of such charges (e.g., daily debit balances) for, for example, the prior three months of interest cycles.

LPI calculations may be performed as is conventionally known.

The default interest rate, i.e., the base lending rate, may be used for charge calculations, for example, margin interest calculations. Rate amounts for each reference interest rate may be entered through the user interface, and may be entered with up to ten decimal places. Rate selections may be made from a menu including selectable entries for the base lending interest rate, federal funds interest rate (e.g., the interest rate charged by banks with excess reserves at their Federal Reserve branch to other banks; a short term money interest rate that may change throughout a given day; Fed Funds can be quoted as the opening interest rate, closing interest rate, or effective (average) interest rate), LIBOR-30 day , prime interest rate, fixed interest rate and other interest rates as deemed appropriate by system administrators or users.

A grid of data may be associated with each reference interest rate, for example, as shown in Table 1, below. Both the dollar ranges and percentage amounts for each grid breakpoint may be customized and displayed via the user interface of the interest determination system. Conventional grid break points may be the default for each grid with a 0% associated with each breakpoint, until input into the on-line, overlays or changes the details.

TABLE 1

| | | |
|---|---|---|
| $0 | To | $24,999 |
| $25,000 | To | $49,999 |
| $50,000 | To | $74,999 |
| $75,000 | to | $99,999 |
| $100,000 | to | $249,999 |
| $250,000 | to | $499,999 |
| $500,000 | to | $999,999 |
| $1,000,000 | to | $1,999,999 |
| $2,000,000 | to | $4,999,999 |

| | |
|---|---|
| $5,000,000 | and above |

An unlimited number of additional breakpoints may be allowed for, ranging from $0 to $1,000,000,000. As explained below, grids may be customized to be specific to a particular client number, organization, line of business, financial products, wire codes, account. ranges, etc.. A default grid may include additional or more a more limited number of breakpoints.

The default reference interest rate may be the base lending interest rate for debit interest. There may or may not be default interest rate for short rebates and credit interest. The interest rates associated with short rebates and credit interest may be obtained from prime broker systems, e.g., systems that aggregate brokerage data. Each account may have a reference interest rate specified.

In accordance with at least one embodiment of the invention, an account is charged an interest rate of interest daily, based on the reference interest rate and the debit balance for that day. If, for example, an account's interest charge is based off of the LIBOR-30 interest rate and that interest rate changes every couple of days, the account's interest for any day, may be calculated using whatever the LIBOR-30 interest rate was for that day. If that account's debit balance changes, and the debit balance falls into a different range on the grid associated with the reference interest rate, the difference in the mark up/down over the reference interest rate will be applied, and the interest rate will change.

In accordance with at least one embodiment of the invention, the approved amount for a line of credit for a customer may also be recorded and displayed on a customer statement generated by the system.

The interest close, e.g., the day the system calculates average balances, applies the interest rate and charges the clients' accounts, may be on a designated date within a time period, for example, the twenty-first day of each month, or the business day prior if the twenty-first is a non-business day, (e.g., weekend or holiday), except December when it may be, for example, the thirty-first or the last business day of the fiscal year. The interest determination system may also be built to also allow a simple change to calendar month-end and/or fiscal year end Year To Date (YTD) accounting.

The interest determination system may also calculate out of cycle closes for transferred accounts. For example, the interest determination system may project interest for transferred accounts based upon the data passed to it by an account transfer system. Transferred accounts may then close on the date indicated by an account transfer system and journals may be booked that day for the amount projected and passed to the National Securities Clearing Corp. (NSCC). If the settlement date for an account transfer overlaps the cycle close, the interest may not be booked until the date indicated by the account transfer system. At that time, interest may be charged for the prior cycle and the days in the current cycle. If the account transfer is canceled prior to the charge but after the cycle close date, the charge may be booked on the date of the account transfer cancel as of the prior cycle close date and the interest determination system may continue to accumulate balances for that account.

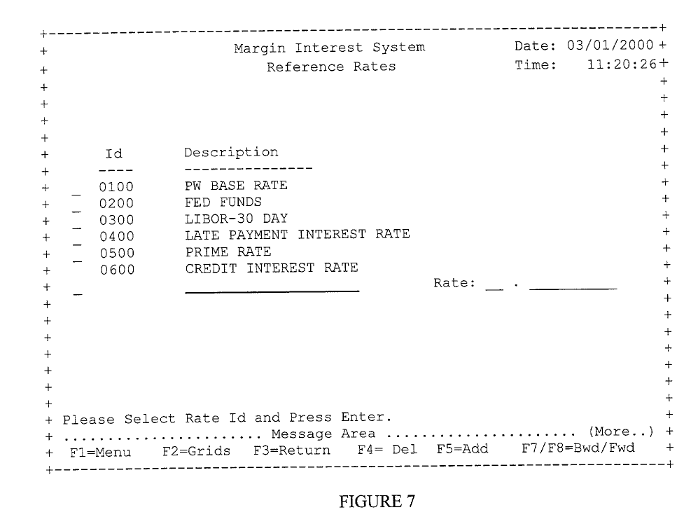

On-line reporting of various cuts of creditline loan payout interest rates, etc., may be available to margin marketing and sales, branch administration and other select users of the interest determination system. In accordance with at least one embodiment of the invention a “Reference Interest Rates” screen may be included in the user interface. An example of the “Reference Interest Rates” screen is illustrated in FIG. 7. This screen can be reached from various other screens included in the user interface (explained below) to display a list of available reference interest rates. User interaction with this screen is directed at the maintenance of valid reference interest rates and their associated identification data (“IDs”). New reference interest rates may be added to the bottom of the list of reference rates and may be sorted alphabetically for display. After a user presses the enter key from a key board coupled to or included in the system, new rates may be created with an effective date as of the first day of the current cycle. In order for the reference interest rate to be active, a grid is created for it (as explained herein).

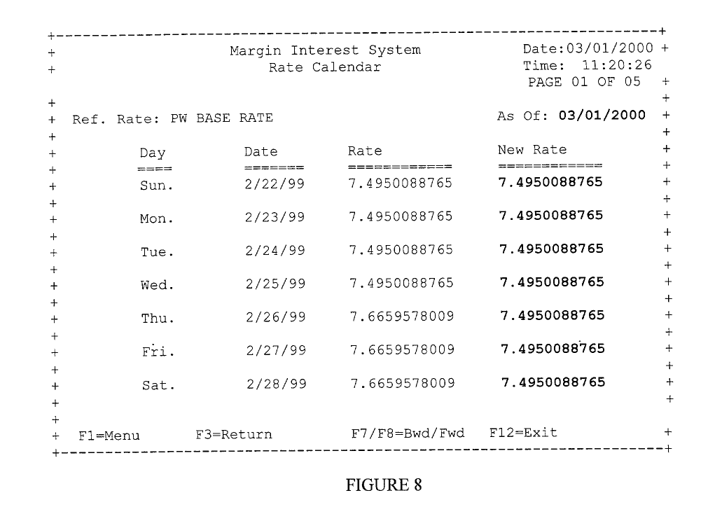

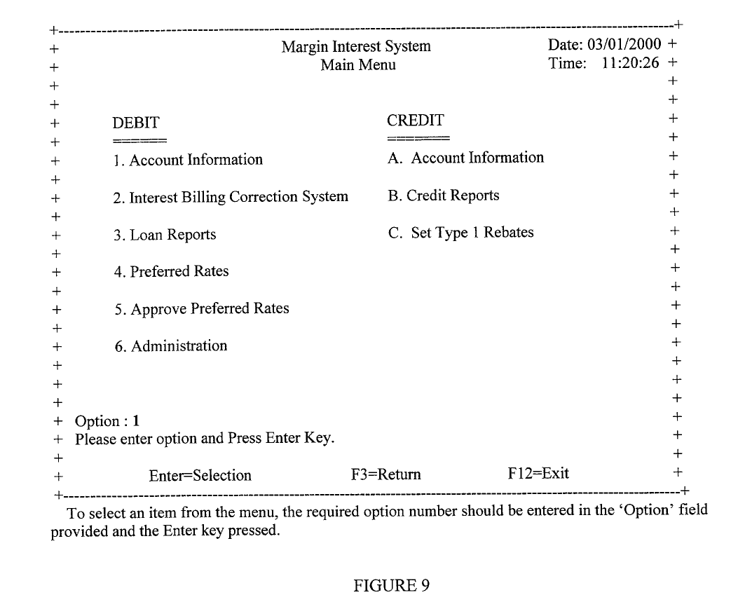

While the “Reference Interest Rates” screen is displayed, receipt of an indication that the user has pressed the enter key after selecting a desired interest rate ID may trigger the display a “Rate Calendar” screen (an example of which being illustrated in FIG. 8), which may display to the user the interest rate for each day in the current interest cycle and allow changes to the interest rate for any date going forward. Receiving an indication that the user has pressed the F1 key may trigger display of the “Main Menu” screen (an example of which being illustrated in FIG. 9), explained herein. Receiving an indication that the user has pressed the F2 key may allow the user to create a new grid for the selected rate. Receiving an indication that the user has pressed the F3 key may trigger display of a previously displayed screen. Receiving an indication that the user has pressed the F4 key may trigger deletion of an existing reference rate. This may be a logical delete in order to preserve history. Receiving an indication that the user has pressed the F5 key may trigger the addition of a new reference rate. Receiving an indication that the user has pressed the F9 key may approve new interest rate data entered. Receiving an indication that the user has pressed the F7 or F8 keys may allow the user to scroll backwards and forwards within the interest rate calendar screen, respectively. Receiving an indication that the user has pressed the F12 key may trigger the system to exit the user therefrom.

Turning to the “Rate Calendar” screen (see FIG. 8), display of that screen can be triggered by a user placing the cursor on the screen next to an interest rate ID and pressing the enter key when the “Reference Interest Rates” screen is displayed. The user can update the rates from the rates calendar screen by typing the new interest rate on the date that the new interest rate is to become effective. The interest rate may remain in effect until a new interest rate is entered by the user. Only authorized users may be able to update these rates.

On the “Rate Calendar” screen, an optional “as of” date may also be entered to display previous cycle calendars. If entered, it may be necessary for this date to be prior to the current date but not more than two years in the past. Receiving an indication that the user has pressed the enter key may edit any new rates that have been entered, and allow the user to verify the rate(s) before pressing the F9 key to approve them. Receiving an indication that the user has pressed the F1 key may bring the user back to the “Main Menu” screen (see FIG. 9). Receiving an indication that the user has pressed the F3 key may trigger display of a previously displayed screen. Receiving an indication that the user has pressed the F9 key may apply the new rates to the data stored in the system, after the user has verified them. The option to press the F9 key may or may not be displayed until the user has pressed the enter key and verified his interest rate changes. Receiving an indication that the user has pressed the F7 or F8 keys may trigger scrolling backwards or forwards within the screen, respectively. Receiving an indication that the user has pressed the F12 key may trigger the system to exit the user therefrom.

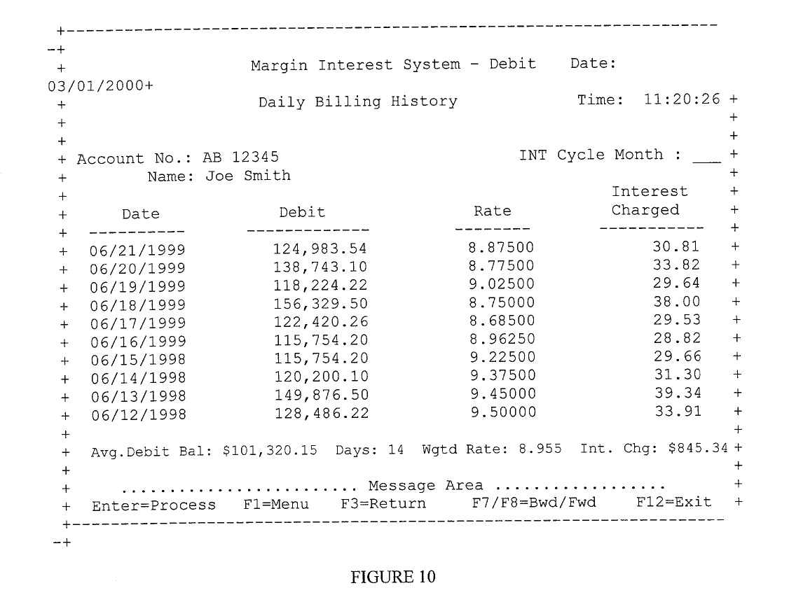

In accordance with at least one embodiment of the invention, interest rate and charge history may also be viewable by a user via the user interface associated with the interest determination system and may include various types of data. For example, a history of daily rolling account balances for a plurality of previous interest cycles (that is, the data displayed on this screen may include data for the current day and a plurality of previous days), which includes the current cycle may be displayed on a “Daily Billing History” screen, an example of which is illustrated in FIG. 10.

While the “Daily Billing History” screen is displayed, receipt of an indication that the user has pressed the enter key after entering a new account number or different interest cycle, will process the request and display the desired data. Receiving an indication that the user has pressed the F1 key may trigger display of the “Main Menu” screen (see FIG. 9). Receiving an indication that the user has pressed the F3 key may trigger display of a previously displayed screen. Receiving an indication that the user has pressed the F7 or F8 keys may trigger the capability to scroll backwards or forwards within the screen, respectively. Receiving an indication that the user has pressed the F12 key may trigger the system to exit the user therefrom.

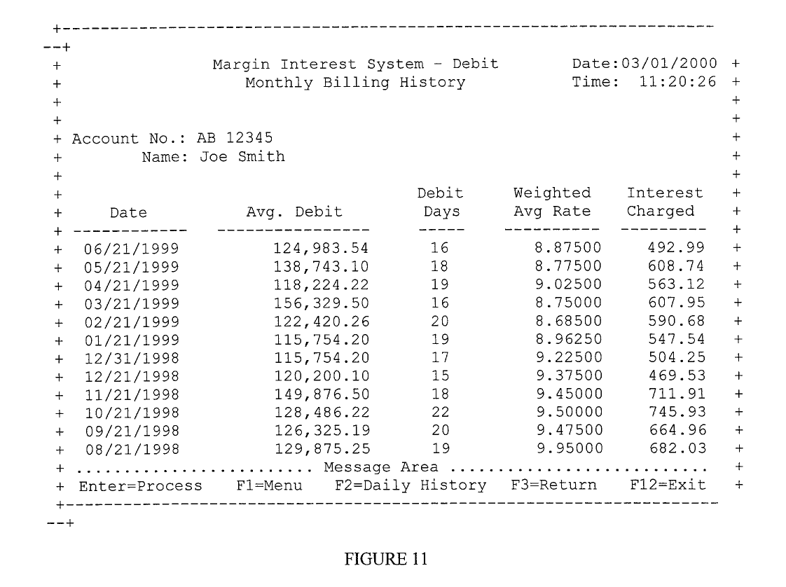

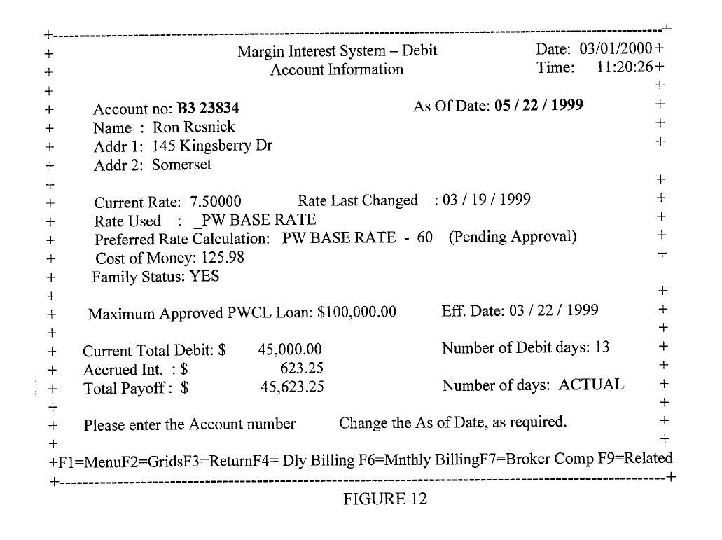

Similarly, by account, a rolling twelve months of monthly interest charges/credits may be displayed on a “Monthly Billing History” screen, an example of which is illustrated in FIG. 11. Display of the “Monthly Billing History” screen may be triggered by receiving an indication that the user has pressed the F6 key while a “Debit Account Information Screen” (an example of which being illustrated in FIG. 12) explained in detail herein. The “Monthly Billing Screen” may display the average debit and average interest rate as of the closing dates for a plurality of time periods, e.g., 12 months on a rolling basis. Thus, the “Monthly Billing History” screen may display the monthly billing history for a particular account for the past twelve months.

While the “Monthly Billing History” screen is displayed, receipt of an indication that the user has pressed the enter key after entering an account number at the top of the screen may trigger display of data associated with that account number. Receiving an indication that the user has pressed the F1 key may trigger the display of a “Main Menu” screen (see FIG. 9) explained in detail herein. Receiving an indication that the user has pressed the F2 key may trigger display of the “Daily Billing History” screen (see FIG. 10) for the same account. Triggering display of the “Daily Billing History” screen from the “Debit Account Information Screen” (see FIG. 12), may result in the data for a current interest period being displayed. Triggering display of the “Daily Billing History” screen from the “Monthly Billing History” screen, may result in the default display including data from a previous cycle.

While the “Monthly Billing History” screen is displayed, receipt of an indication that the user has pressed the F3 key may trigger display of the “Debit Account Information” screen (see FIG. 12). Receiving an indication that the user has pressed the F12 key may trigger the system to exit the user therefrom.

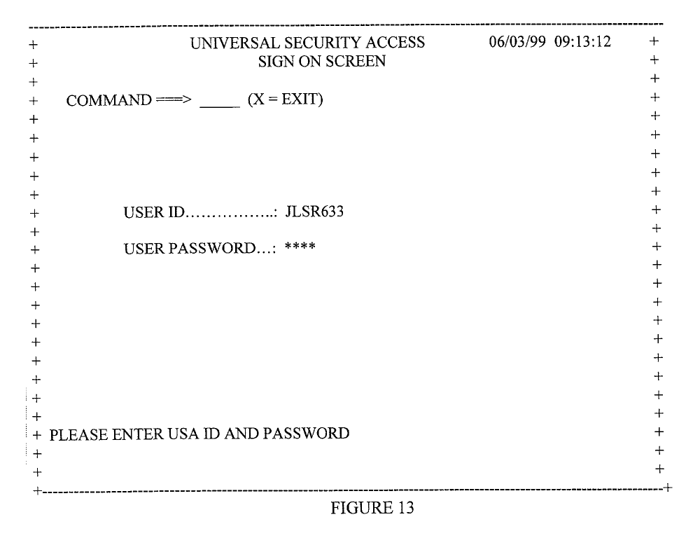

In accordance with at least one embodiment of the invention, on-line access may be controlled by an access entitlement system. Access may be provided to all or some group of office systems, divisions, correspondents, personnel, etc. Security may be provided to allow changes to be made only by those given specific authorization for specific levels of activity. As a result, a “Sign On” screen may be provided in the user interface that may act as a primary entry point into the interest determination system. The “Sign On” screen, an example of which is illustrated in FIG. 13, may be a universal security access screen that may be used by many systems and software applications. The “Sign On” screen may be accessible by entering a transaction identifier and may be used by users who are not using a particular workstation platform; rather, the “Sign On” screen may merely be an entitlement system screen and need not be implemented as part of the interest determination system. The “Sign On” screen may allow the user to enter their ID and password, which may be required to access the interest determination system. Alternatively, the “Sign On” screen may be bypassed when a user enters the interest determination system through a secure or trusted platform or system since the user may have already had to enter his/her ID and password.

While the “Sign On” screen is displayed, receipt of an indication that the user has pressed the enter key may trigger editing and validation of the ID and password that have been entered on the screen. If it is a valid ID and password, this validation may trigger display of the “Main Menu” screen (see FIG. 9). If the ID or password are not valid, an error message may be displayed.

The “Main Menu” screen is the central menu for the interest determination system. This screen may be invoked, as explained above, by correctly typing in a valid security ID and password from the “Sign On” screen, or by clicking on an appropriate icon on a toolbar associated with another system or platform connected to the interest determination system. The “Main Menu” includes functionality associated with debit and credit amounts administered and and/or analyzed by the interest determination system. Thus, there is debit functionality and credit functionality. This functionality is implemented at least in part by a user selecting from various options listed on the “Main Menu” screen. The debit functionality options will now be described.

Receipt of an indication that the user has selected the first option (Option 1: Account Information) may trigger display to the user of a “Debit Account Information” screen (see FIG. 12), which may display account data, such as interest rate, approved loan amount, debit balance, etc., at the account level.

“What If” scenarios may also be calculated for payoff purposes. That is, the interest determination system may provide a “what if” capability to allow projections of interest on non-transferred closes without the actual booking of the charge. The charge may be booked in a normal interest cycle.

The “Debit Account Information” screen enables the user to enter an account number, and view all the information related to that account, as of a specific date. The data entry fields on the “Debit Account Information” screen include a field for an account number and, optionally, an “as of” date field. The account number may be a required field. If someone from a particular organization or office is logged on to the interest determination system, the account prefix (e.g., the first two characters of the account number) may automatically be populated with the a number associated with that organization or office, which may not be changed since those users may only have access to their own organization or office's accounts. In the case of users who have access to data associated with multiple organizations or offices (e.g., administration or management personnel), the account prefix may not be automatically populated.

Optionally, an “as of” date may be entered as well. The “as of” date field will initially contain the current date and the data that is displayed for the account number may be for the current date, unless a new date is entered into the “as of” date field. If a date is entered into the “as of” date field that is less than the current date, all data for the account may be displayed as of that date. If the date that was entered into the “as of” date field is a future date, all of the account's data may be displayed as of the current date, except for the current debit, accrued interest, and total debit fields, which may contain projected data, as of the future date. Identifiers associated with the field descriptions may change to indicate that displayed data is projected.

The data that is displayed for an account may include various fields, for example, name (e.g., the name of the account's owner), address (e.g., the address of the account's owner), current interest rate (e.g., the interest rate that is currently used in the calculation of interest for this account, whether it is a reference interest rate, based on an associated grid, or a preferred interest rate), rate last changed (e.g., the date that the interest rate for this account was last changed), reference interest rate (e.g., the name of the interest rate that is being used for interest calculations, e.g., base lending rate, LIBOR-30, prime, etc.), preferred interest rate (e.g., if this account has been assigned a preferred interest rate, a description of the preferred interest rate may be displayed; the description may include the name of the reference interest rate plus or minus a number of basis points; if the preferred interest rate has not yet been approved, the field may include a “(Pending Approval)” message, as well), family status (e.g., ‘YES’ if the account is part of a family of related accounts; if the account is not part of a family of related accounts, the family status field will be ‘NO’), and cost of money (e.g., indicates the cost of money charge from the beginning of the current interest cycle, to the date in the “as of” date field; this field may be darkened when displayed to users having an authorization level below a certain level).

The displayed data may also include data associated with or indicating a maximum approved credit line loan (e.g., indicating the maximum amount of money that this account has been approved for in a credit line loan), current debit (e.g., indicating the debit balance for the date shown in the “as of” date field), accrued interest (e.g., indicating the interest charge that has been accrued from the beginning of the current interest cycle, to the date in the “as of” date field), total payoff (e.g., indicating the sum of the amounts in the current debit field and the accrued interest field), number of days (e.g., indicating the number of days in a year, for example, 360 days, 365 days, or actual, that was used in the calculation of the interest charges for this account; if “actual” is displayed, it means that the actual number of days in the current year was used, e.g., 366 if Leap Year, 365 if not).

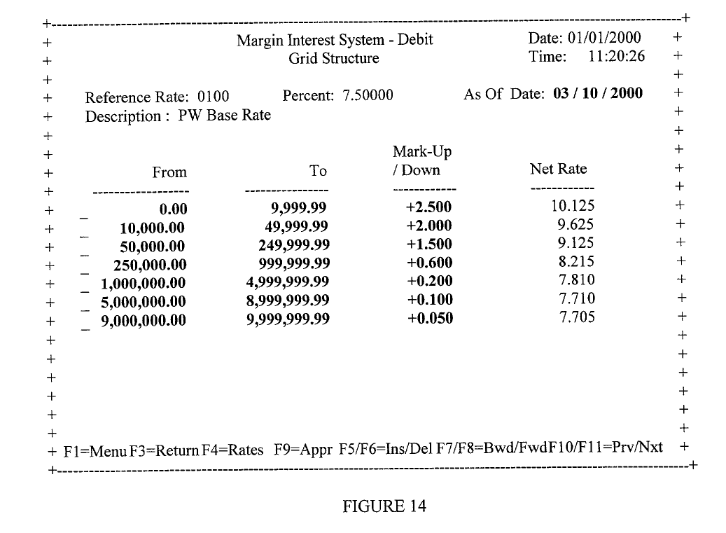

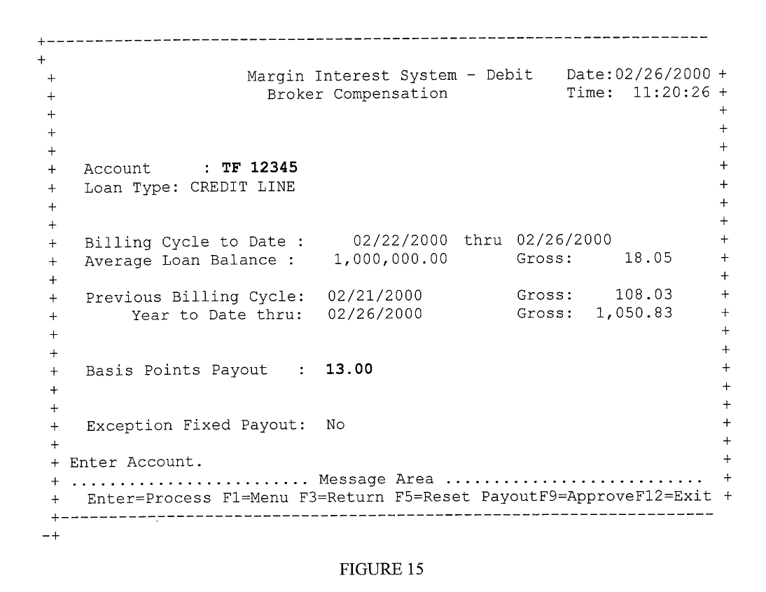

While the “Debit Account Information” screen is being displayed, receipt of an indication that the user has pressed the F1 key may trigger output of the “Main Menu” screen (see FIG. 9). Receiving an indication that the user has pressed the F2 key may trigger output of the “Grid Structure” screen, an example of which being shown in FIG. 14 (explained in detail herein), which may display the grid information that is associated with the reference interest rate that is shown on the current screen if this account does not have the preferred interest rate. Receiving an indication that the user has pressed the F3 key may trigger output of a previously output screen. Receiving an indication that the user has pressed the F4 key may trigger output of the “Daily Billing History” screen (see FIG. 10). Receiving an indication that the user has pressed the F6 key may trigger output of the “Monthly Billing History” screen (see FIG. 11). Receiving an indication that the user has pressed the F7 key may display a “Broker Compensation Screen”, an example of which being illustrated in FIG. 15.

In accordance with at least one embodiment of the invention, in a brokerage environment, brokers' compensation may be expressed as a percentage of spread. Payments may be set up for either margin account or loan account debits. These payouts may be set at a fixed amount of basis points. Payouts may occur periodically, e.g., monthly. A default broker payout interest rate for loan account debit balances may be set, unless a special interest rate is set at the account level for accounts coded after a predetermined date, unless overridden. This default payout interest rate may be included in coding included in a broker compensation system, with the ability to change. The ability to input rates to the tenth decimal place may be provided. Special broker payout rates may be negotiated at the account level and may reside in one or more of the databases included in the memory illustrated in FIG. 6.

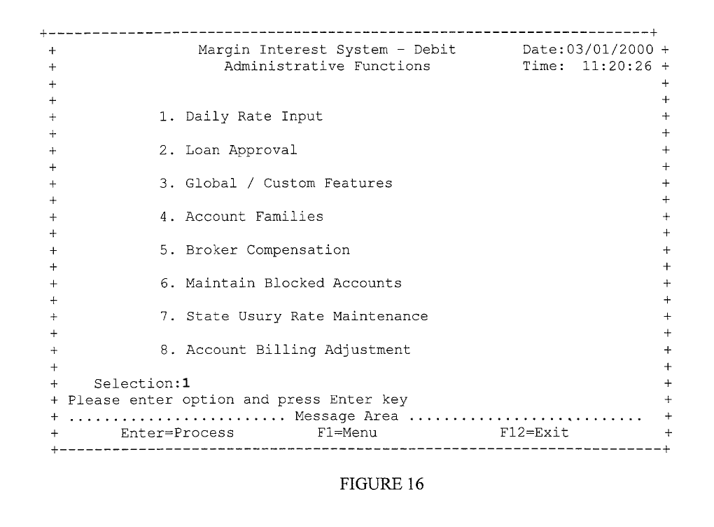

Display of the “Broker Compensation” screen may also be triggered by selecting Option 5 from the “Administrative Functions Menu” screen (an example of which being illustrated in FIG. 16, explained in detail herein). Triggering display of the “Broker Compensation Screen” from the “Administrative Functions Menu” screen may allow users with administration authority to enter an account number. The compensation information for the account may then be retrieved and ‘billing cycle to date’ gross amount may be calculated and displayed. The ‘basis points payout’ field may be calculated and available for adjustments to the compensation rate. The ‘exception fixed payout’ field may indicate if this account has had the payout adjusted in this way. The user may then make the necessary changes and approve them by receiving an indication that the user has pressed the F9 key. The account number may be overtyped to process another account.

The “Broker Compensation” screen may also be displayed as a result of a user pressing the F7 key when viewing the “Debit Account Information” screen (see FIG. 12).

It should be appreciated that a non-administration level user may be presented with the “Broker Compensation” screen via the “Debit Account Information” screen. The account information may be for display only, not permitting editing. No modifications may be possible and the only valid option may be to trigger display of a previously displayed screen (the F3 key).

While the “Broker Compensation” screen is displayed, receipt of an indication that the user has pressed the enter key may edit the data and give the user a chance to verify it before receiving an indication that the user has pressed the F9 key to approve. Receiving an indication that the user has pressed the F1 may trigger display of the “Main Menu” screen (see FIG. 9). Receiving an indication that the user has pressed the F3 key may trigger display of a previously displayed screen. Receiving an indication that the user has pressed the F5 may change basis points payout without exception. Gross of broker compensation for current cycle may be changed according to basis points. Receiving an indication that the user has pressed the F9 key may allow the user to approve the data after he has pressed the enter key and verified it. The option to press the F9 key may or may not be displayed until the user presses the enter key. Receiving an indication that the user has pressed the F12 key may trigger the system to exit the user therefrom.

Functionality associated to related accounts, e.g., the ability to charge related family accounts the same interest rate regardless of size of the debit balance in the individual accounts, may be applied to broker compensation calculations as well. Additionally, broker payouts may take into account any related account functionality, which may allow broker payouts to be calculated based on a family of accounts.

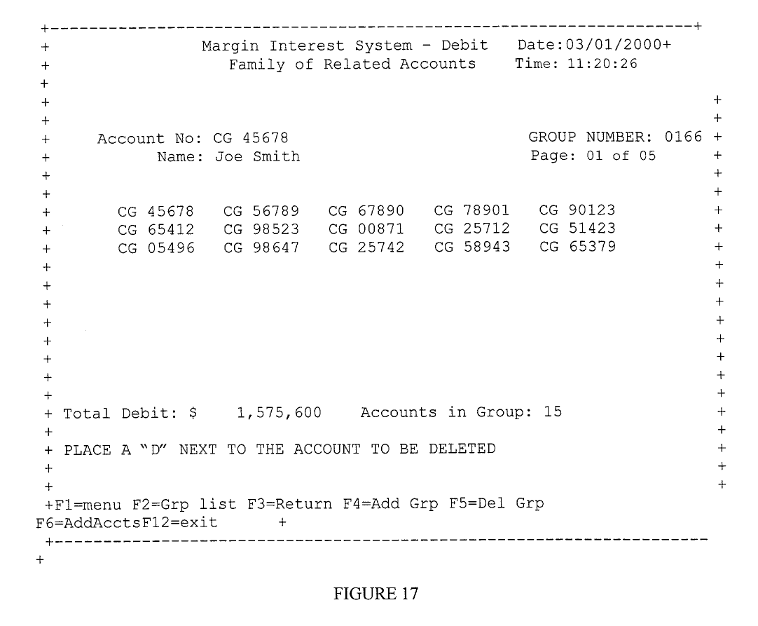

Returning to “Debit Account Information” screen functionality (see FIG. 12), while that screen is displayed, receipt of an indication that the user has pressed the F9 key may trigger output of a “Family of Related Accounts” screen, an example of which being illustrated in FIG. 17, and if this account is part of a family of accounts, otherwise the option to press the F3 key may not be displayed. Receiving an indication that the user has pressed the F12 key may trigger the user to be exited from the system.

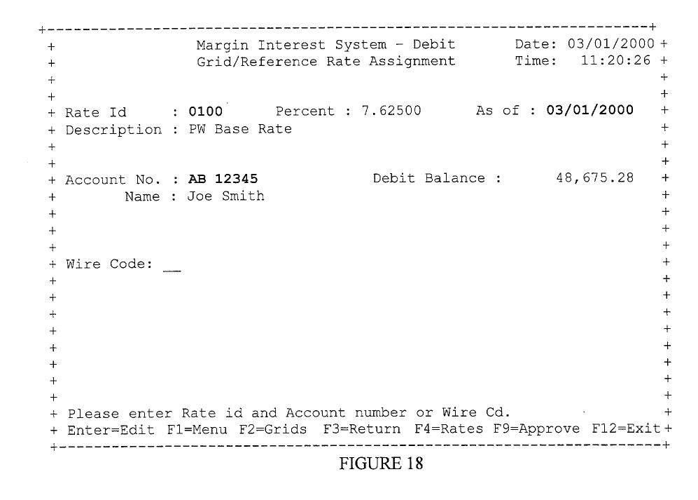

Returning to the “Grid Structure” screen (see FIG. 14) functionality, the screen can be accessible by a user by, for example, the user pressing the F2 key from a “Grid/Reference Rate Assignment” screen (an example of which being illustrated in FIG. 18) or by the pressing the F2 key from the “Debit Account Information” screen (see FIG. 12). The “Grid Structure” screen may be used to display all the grids associated with the reference interest rate from a previous screen.

Only users with a sufficiently high access authority can make modifications to the grid structure. An authorized user may add new amount ranges, delete amount ranges, or type over any of the amounts in the existing ranges in the grid. However, when making these modifications the user may be required to make sure that there are no gaps between ranges (all amounts need to be accounted for in the grid). The user may also modify the mark-up/down rate, which is an additional interest rate based on the debit balance, which may be added to the base reference rate.

An optional “as of” date may be entered via the “Grid Rate/Reference” Rate screen (an example of which being illustrated in FIG. 18). This date may be greater than or less than the current date. Dates greater than the current date may only calculate for the period of time until the end of the current interest cycle. If changes to the grid are made, and the “as of” date is populated with a date that is either greater than or less than the current date (within the current interest cycle), the changes may be effective as of that date. If no changes are made to the grid, and a date greater than the current date is entered into the “as of” date, an error message may be displayed. If no changes are made to the grid, and a date less than the current date is entered, the grid structure as of that date will be displayed.

If the user wishes to change the grid structure of grids related to a different reference rate, the user may do so by typing over the reference interest rate ID with a new reference interest rate ID. The grid structures associated with this new reference interest rate may be displayed, beginning with the default grid structure.

The reference interest rate ID has multiple components. For example, in accordance with at least one embodiment of the invention the reference interest rate ID has two components: the first two characters of the reference interest rate ID identify the reference rate; and the second two characters identify the grid associated with that reference rate. A default grid for a reference interest rate can always be identified by a “01” in position 3 and 4 of the reference interest rate ID. The base lending interest rate is the default reference interest rate for all accounts and can always be identified by a “01” in positions 1 and 2 of the reference interest rate ID. Therefore, a reference interest rate ID of “0101” may identify the interest rate as the base lending interest rate and the grid will be the default grid associated to that rate. New grids may be created with an effective date of the first day of the current cycle.

While the “Grid Structure” screen (see FIG. 14) is displayed, receipt of an indication that the user has pressed the enter key may trigger processing or editing any changes that were made to the grid and/or mark-up/down rates, and provide the user with an opportunity to review the edits before pressing the F3 key to approve them. If no changes are made, but an “as of” date is entered for a date prior to the current date, the grid may be displayed as of that date. Similarly, the user pressing the F1 key may display the “Main Menu” screen (see FIG. 9). Receiving an indication that the user has pressed the F3 key may display the previously displayed screen. Receiving an indication that the user has pressed the F5 or F6 keys may insert or delete, respectively, a line in the grid.

If the user wants to insert a new grid line between two existing grid lines, or prior to the first grid line, the user may position the cursor on the grid line that would come after the new grid line and press the F5 key. This may shift all grid lines beginning from where the cursor is positioned, down one line, making room for the new line. A new grid line to be inserted at the end of the grid, can just be typed in after the last grid line. If the user wants to delete a grid line, the user may position the cursor on the line to be deleted and press the F6 key. Again, no gaps may be left in the grid (all amounts may be accounted for). An error message may be displayed and the database may not be updated with the changes if gaps exist.

While the “Grid Structure” screen is displayed, receiving an indication that the user has pressed the F7 or F8 keys may trigger scrolling backward or forward, respectively, on the same grid, should the grid be too large to fit on one screen. Receiving an indication that the user has pressed the F9 key may trigger the user being prompted to approve changes. Pressing the F9 key may not be initially displayed as a PF key option unless changes have been made and the enter key has been pressed. Along with the F9 key, the following message may be displayed: “Create New grid or Change existing grid? _(N/C)”, which may allow the user to indicate if he wants the grid that he just modified to become a brand new grid, or if it should just overlay the existing grid. After a user presses the F9 key, all changes may be applied to the database. If, for example, the user were to modify the default grid for the base lending interest rate (e.g., interest rate ID: 0101), and an “N” was entered, a new grid may be created that can be identified with a reference interest rate ID of ‘0102’ (assuming there is not already an 02 grid for reference interest rate 01). If a “C” was entered, in effect, the default grid for this reference interest rate may be changed and the reference interest rate ID may still be 0101.

While the “Grid Structure” screen (see FIG. 14) is displayed, receipt of an indication that the user has pressed the F10 or F11 keys may trigger display the previous or next grid in the list of grids associated with the reference rate, assuming there is more than one grid associated to the reference rate. Receipt of an indication that the user has pressed the F12 key may trigger the system to exit the user therefrom.

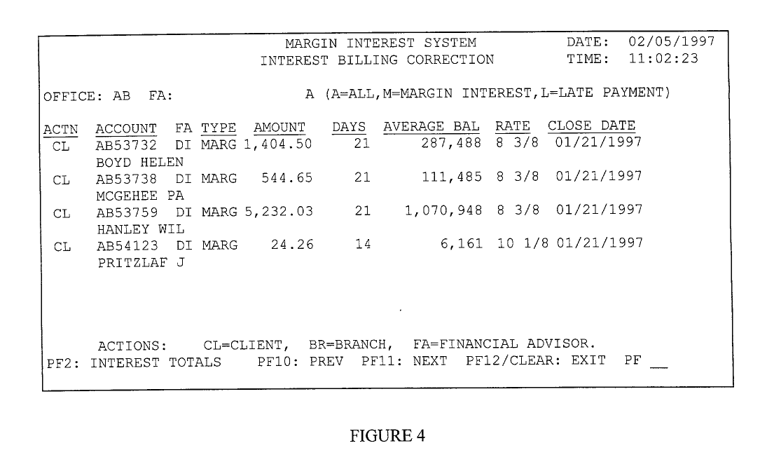

Returning to the “Main Menu” screen functionality description (see FIG. 9), while the “Main Menu” screen is displayed, selection of the second option (Option 2: Interest Billing Correction System) may trigger display to the user of a front end of an interest billing correction system, e.g., a “Balance and Interest Rate Adjustment” screen, which may allow an authorized user to adjust balances and rates prior to statement processing, such as the conventional one illustrated in FIG. 4.

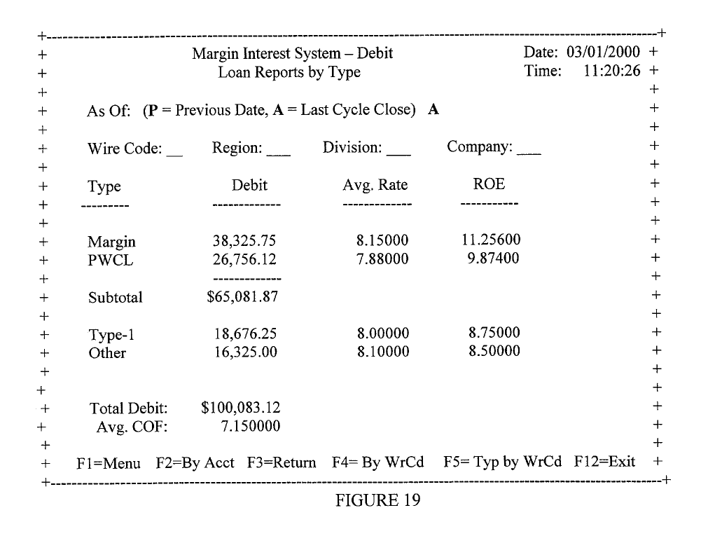

While the “Main Menu” screen is displayed, selection of the third option (Option 3: Loan Reports), may trigger display to the user of a “Loan Report By Type” screen (an example of which being illustrated in FIG. 19), which may allow the user to view summary data by type, for all types within a wire code, region, division, etc. Other reports may also be available from this screen.

The “Loan Reports By Type” screen may display loan reports by type for a particular wire code, region, division, or company, as of the previous night's close or as of the last cycle close date. The “Loan Reports By Type” screen may show a summary line for each type within a wire code, region, division or company. This report can be as of the previous night's close or as of the last interest cycle's close. The only fields into which data may be allowed to be entered may be the as of, wire code, region, division and company fields. In the “as of” field, if a ‘P’ is entered, the data may be displayed as of the previous night's close; whereas, if an ‘A’ is entered, the data may be display as of the close of the last interest cycle. The default for the “as of” field may be ‘P’.

The wire code, region, division and company fields may be mutually exclusive (only one of them may be entered at a time). If a user from a branch is logged on, they may potentially only be allowed to view data from their own branch or a satellite branch; therefore, they potentially may not have the option of entering a region, division or company, and these fields potentially may not be displayed. Similarly, a user from a region may potentially only see those wire codes within his own region; therefore, the user may potentially not have the option of choosing a different region, or a division or company, and these fields may potentially not be displayed to him. A user at the division level could possibly enter a particular wire code or region within his division, but that user may or may not be allowed to enter a different division or a company; therefore, these fields may or may not be displayed to him. A user at the company level may have access to all wire codes, regions, or divisions within his company but not other companies; therefore, company field may or may not be displayed to him. Users with access to all data, such as a system administrator, may be able to enter data into any one of these fields, including company. When the “Loan Reports By Type” screen is first displayed, the screen may default to the highest level of data that the user is authorized to view.

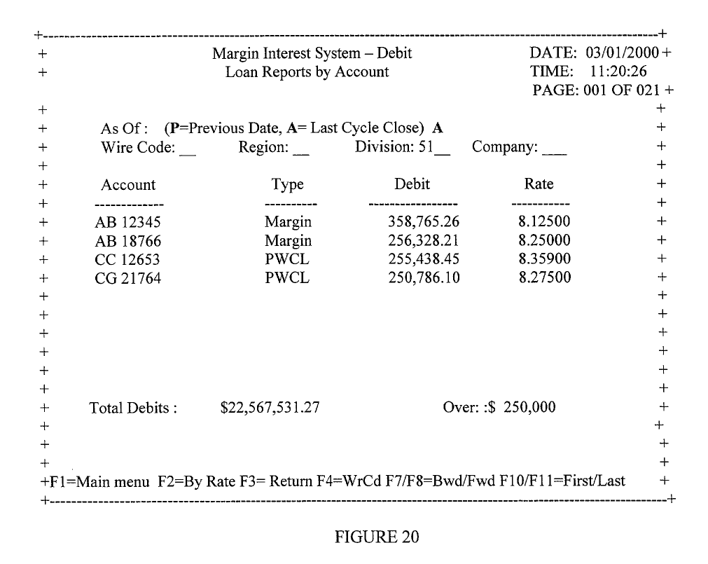

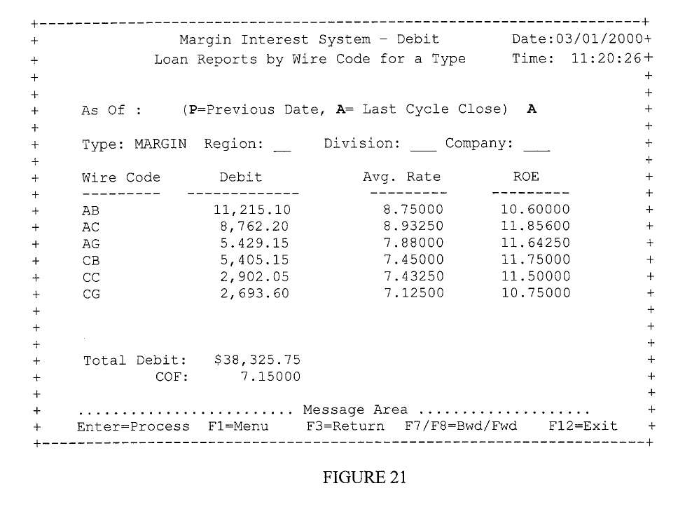

While the “Loan Reports By Type” screen is displayed, receipt of an indication that the user has pressed the enter key may trigger processing a request for data that has been entered on the screen. Receiving an indication that the user has pressed the F1 key may trigger display of the “Main Menu” screen (see FIG. 9). Receiving an indication that the user has pressed the F2 key and entering data indicating a particular wire code, region, division, or company may trigger display of the “Loan Reports By Account” screen (an example of which being illustrated in FIG. 20), which may display information for the largest debit balance accounts over the entered limit, for the selected wire code, region, division, or company. Receiving an indication that the user has pressed the F3 key may trigger display of a previously displayed screen. Receiving an indication that the user has pressed the F4 key and entering data indicating a particular region, division, or company may display a “Loan Reports By Wire Code” screen, which may display information at the wire code level, for all wire codes within the selected region, division, or company. Receiving an indication that the user has pressed the F5 key after selecting a particular region, division, or company, and placing the cursor next to a particular type, may trigger the display of the “Loan Reports By Wire Code for a Type” screen (an example of which being illustrated in FIG. 21), which may display information at the wire code level, for the selected type, for all wire codes within the selected region, division, or company. Receiving an indication that the user has pressed the F12 key may trigger the system to exit the user therefrom.

The “Loan Reports By Account” screen may display the net debit balance by type at the account level for the selected wire code, region, etc., as of the previous night's close or as of the close of the previous interest cycle. Potentially, only the accounts with the largest debit balance over the entered limit may be displayed. The fields into which data can be entered include the “as of”, wire code, region, division, company, and “over” fields. In the “as of” field, if a ‘P’ is entered into the field, the data will be displayed as of the previous night's close; if an ‘A’ is entered into the field, the data will be display as of the close of the last interest cycle. The wire code, region, division and company fields may be mutually exclusive (only one of them may be entered at a time).

If a user from a branch office is logged onto the interest determination system, they may only be allowed to view data from their own branch or a satellite branch; therefore, they may not have the option of entering a region, division or company, and these fields may or may not be displayed. Similarly, a user from a region may only be allowed to view those wire codes within his own region; therefore, he may or may not have the option of choosing a different region, or a division or company, and these fields may or may not be displayed to him. A user at the division level may enter a particular wire code or region within his division, but he may or may not be allowed to enter a different division or a company; therefore, these fields may or may not be displayed to him. A user at the company level may have access to all wire codes, regions, or divisions within his company but not other companies; therefore, the company field may or may not be displayed to him. A user that has access to all data, such as a system administrator, may be able to enter data in any one of these fields, including company.

Upon initial display of the “Loan Reports By Account ” screen, the data displayed may be for the wire code, region, division or company that was being displayed on the “Loan Reports By Type” screen prior to pressing the F2 key. Input of data in the ‘over’ field may allow the user to limit the number of displayed accounts to those having balances over an entered limit. Receiving an indication that the user has pressed the enter key may trigger processing of a request that has been entered on the screen. Receiving an indication that the user has pressed the F1 key may display the “Main Menu” screen (see FIG. 9). Receiving an indication that the user has pressed the F2 key may trigger the display of the presently displayed report but in ascending order by interest rate or by account. The total debit amount shown at the bottom of the screen may be the total for all the pages in the report, not for just the data that is being displayed on the current page.

While the “Loan Reports By Account” screen is displayed, receipt of an indication that the user has pressed the F3 key may display a previously displayed screen. Receiving an indication that the user has pressed the F4 key after entering data indicating a particular region, division, or company, may trigger display of the loan reports by wire code screen, which may display information at the wire code level, for all wire codes within the selected region, division, or company. Receiving an indication that the user has pressed the F7 or F8 keys may trigger the user to scroll backwards or forwards, respectively, through the report screen. Receiving an indication that the user has pressed the F10 or F11 keys may trigger the display of the first or last page of the report displayed on the report screen, respectively. Receiving an indication that the user has pressed the F12 key may trigger the system to exit the user from the system. If a user selects a type of loan report (Margin, Credit line, or Late Payment) account in a previously displayed screen, the system may store the indication of the type until the user presses the F3 key; subsequent to that step the user can again select the type.

Returning to the “Loan Reports By Wire Code For a Type” screen may be included in the user interface(see FIG. 21), this screen may be displayed as a result of receiving an indication that the user has pressed the F4 key when the “Loan Reports By Type” screen (see FIG. 19) is displayed. The “Loan Reports By Wire Code For a Type” screen may display debit amounts at a branch level, for a particular type and a particular region, division or company, which were selected by a user on a previous screen.

A user can overtype the type with a specific type code or “all” to display all type codes. In addition, the user can select a different region, division, or company. Receiving an indication that the user has pressed the enter key after typing over the type or entering a new region, division, or company may trigger processing that request. Receiving an indication that the user has pressed the F1 key may trigger display of the “Main Menu” screen (see FIG. 9). Receiving an indication that the user has pressed the F3 key may trigger display of a previously displayed screen. Receiving an indication that the user has pressed the F7 or F8 key may allow the user to scroll backwards and forwards, respectively, within the report screen. Receiving an indication that the user has pressed the F12 key may trigger the system to exit the user therefrom.

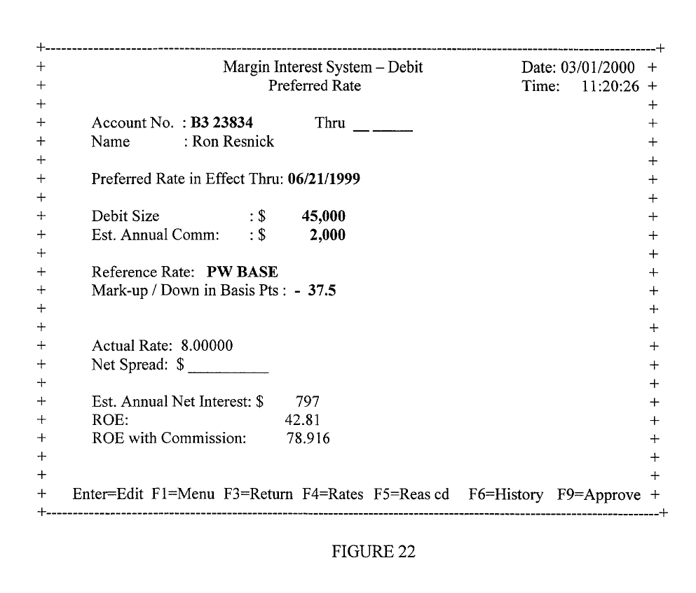

Returning to the “Main Menu” screen functionality (see FIG. 9), selection of the fourth option (Option 4: Preferred Interest Rates), may trigger display to the user of a “Preferred Interest Rates” screen (an example of which is illustrated in FIG. 22), which may allow an authorized user to setup preferred interest rates for an account or a range of accounts. In accordance with at least one embodiment of the invention, a preferred interest rate can be assigned at an account level. If a preferred interest rate is assigned to an account at any point during the interest cycle, it will be effective as of the beginning of the interest cycle. Thus, the preferred interest rate can be set for an account using the “Preferred Interest Rates” screen. All preferred interest rates may need to be approved by management or administration personnel.

Reference rates and preferred interest rates (percentage up or down over grid for a selected reference rate) may be selected for, for example, debit balance charges, credit balance interest, etc. The debit balance charge equals the debit multiplied by the rate. The credit balance interest indicates those accounts that to receive an interest credit on their cash balance. Rate and preferred interest rate changes can be made through the last day of the interest cycle and can be applied to the daily balances for that interest cycle close.

For brokerage firm offices to have the ability to apply default rates to specific entities (i.e., wire code level or groupings of wire codes), the user interface may be capable of being used to apply default reference rates and preferred percentage on balance charges, e.g., margin balance charges, and credit balance interest. Wire code and/or financial advisor level defaults may be entered in profiling screens associated with other systems and fed to the interest determination system for display and utilization.

The interest determination system may allow input of related accounts for the purposes of combined debit account balances to determine the breakpoint interest rate to apply. If the related accounts have different reference rates and/or preferred interest rates then the lowest interest rate may apply as is conventionally possible.

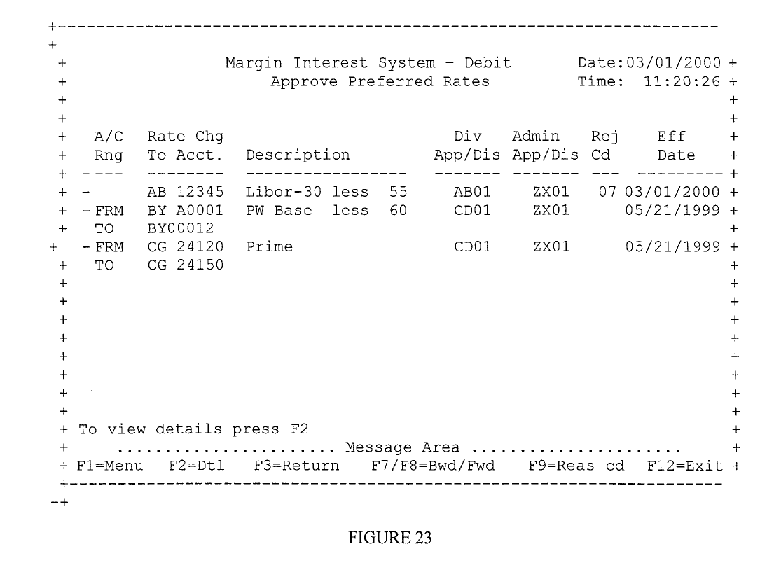

As explained above, the “Preferred Interest Rates” screen can be accessed by selecting the fourth option from the “Main Menu” screen (see FIG. 9). The “Preferred Interest Rates” screen may be configured to allow users that have a relatively high security level to setup preferred interest rates for an account or range of accounts. The “Preferred Interest Rates” screen can also be accessed by selecting an interest rate on the “Approve Preferred Interest Rates” screen (an example of which being illustrated in FIG. 23) and pressing the F2 key. All appropriate fields may be populated so that the user can review the details of the interest rate change.

On initial display of the “Preferred Interest Rates” screen (see FIG. 22) from the “Main Menu” screen (see FIG. 9), the user may enter the following data on the screen: identification of the account number(s), preferred interest rate in effect through an identified date, identification of the debit size, established annual commission, reference rate, mark-up/down in basis points, etc. If the date indicated by preferred interest rate in effect through an identified date is not entered, the interest rate may be effective indefinitely (the field will be displayed as spaces).

The fields associated with actual rate, estimated annual net interest, net spread, return on equity, and return on equity with commission may be darkened because, without the appropriate data, the calculations are invalid. After the appropriate data has been entered, receipt of an indication that the user has pressed the enter key may trigger retrieval of the name and calculate the remaining fields and display them to the user for review. All preferred interest rates may need to be approved by division and/or by administration personnel, before they become available for use.

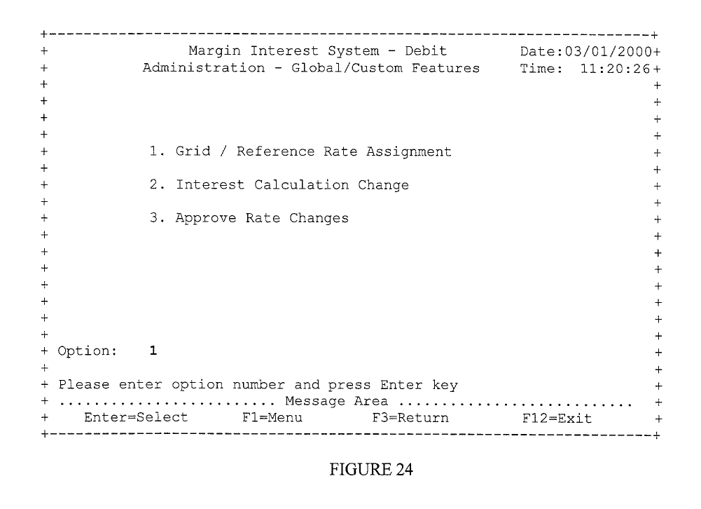

Display of the “Preferred Interest Rates” screen (see FIG. 22) may also be triggered by the user selecting Option 3 on an “Administration Global/Custom Features” screen (an example of which being illustrated in FIG. 24).

Selection of Option 1 of the “Administration Global/Custom Features” screen may trigger display of the “Grid/Reference Interest Rate Assignment” screen (see FIG. 18). Authorized personnel may be allowed to change the default interest rate for debit interest from a “Grid/Reference Interest Rate Assignment” screen. Changes to the default reference interest rate and/or grid for each reference interest rate can be made up until the close of business on the last business day of an interest cycle. The “Grid/Reference Interest Rate Assignment” screen may enable a user with a specified authority to approve or reject requested rates. The “Grid/Reference Interest Rate Assignment” screen may be configured to enable users with the requisite level of administrative authority to assign rates to a particular account or wire code. On initial display of this screen, the base interest rate may be displayed as a default. Users may be able to assign a particular rate/grid to an account by entering the interest rate ID and account number. Users can also assign a rate/grid at the wire code level. An authorized user pressing the F9 key may trigger approval of the rate, the ID of the user and the effective date (e.g., current date) may be added to the grid automatically, and the user may be returned to the previous screen. These updates may appear on the “Grid/Reference Rate Assignment” screen until approved by the appropriate personnel or for the duration of a current session if this was the final required approval. Only requests in need of approval or rejected requests may appear on this screen.

To reject an interest rate assignment request, after having reviewed the account data, the user may press the F5 key to trigger display of a list of disapproval codes and their descriptions. Entering the selected code may transfer the user back to the “Approve Preferred Interest Rates” screen (see FIG. 23) where the reason code and the user ID may have been updated. A next request may then be processed.

If an account already has an approved preferred interest rate and a request is made for a new preferred interest rate (either for a single account or for an account range), the current preferred interest rate may remain in effect (no pending flags may be set on the account table) until the new interest rate has been approved. Receiving an indication that the user has pressed the enter key may trigger entry of all the required data to set a preferred interest rate, editing and validation of the data and output of a prompt to the user for him to review what he has entered, prior to pressing the F9 key, to submit it for approval. Receiving an indication that the user has pressed the F1 key may trigger display of the “Main Menu” screen (see FIG. 9). Receiving an indication that the user has pressed the F3 key may trigger display of a previously displayed screen. Receiving an indication that the user has pressed the F4 key, may trigger display of the Reference Interest Rates” screen (an example of which being illustrated in FIG. 7), which may display a list of the reference rates currently in use.

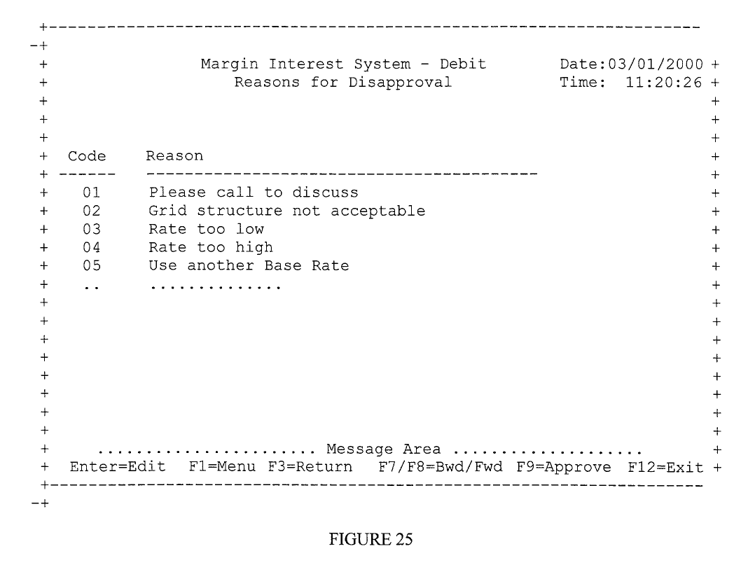

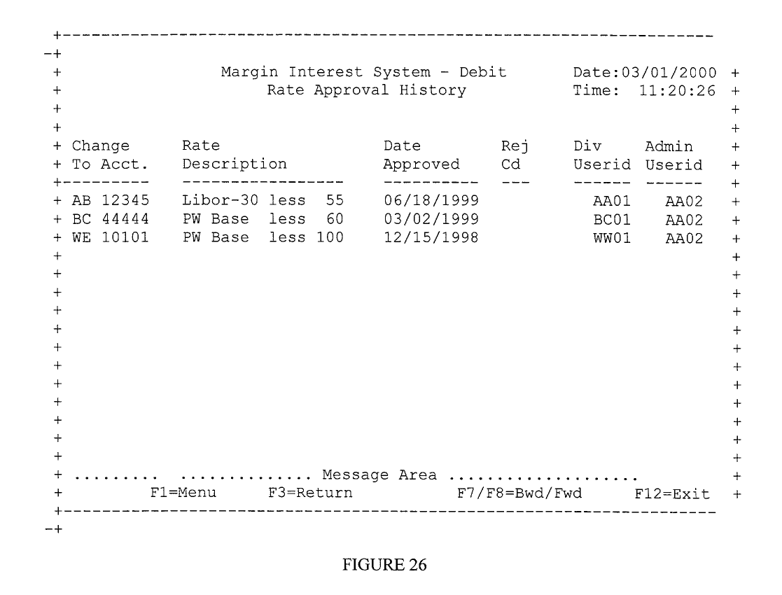

Receiving an indication that the user has pressed the F5 key may trigger display of a “Reasons For Disapproval Codes screen (see FIG. 25), where the user may be allowed to select a reason code for disapproval of the requested preferred interest rate. Following the approval or rejection of the requested rate, the user will be transferred back to the approve “Preferred Interest Rates” screen. Receiving an indication that the user has pressed the F6 key may trigger display of an “Interest Rate Approval History” screen (an example of which being illustrated in FIG. 26), where the user may view all interest rate approvals for preferred interest rate that he has entered over a specific period, e.g., the past 12 months. Receiving an indication that the user has pressed the F9 key may add a requested preferred interest rate to a list for approval by division and administration. The option to press the F9 key may not be displayed until data has been entered and the enter has been pressed. Receiving an indication that the user has pressed the F12 key may trigger the system to exit the user therefrom.

An optional “as of” date may be entered, this date being either a prior or future date, (potentially limited to the current interest cycle).

The “Interest Rate Approval History” screen may display the interest rate changes for the previous 12 months in descending date sequence. While displaying the “Interest Rate Approval History” screen, receipt of an indication that the user has pressed the F1 key may trigger display of the “Main Menu” screen (see FIG. 9). While displaying the “Interest Rate Approval History” screen, receipt of an indication that the user has pressed the F2 key may trigger display of a list of the available disapproval codes and descriptions. Receipt of an indication that the user has pressed the F3 key may trigger display of a previously displayed screen. Similarly, receiving an indication that the user has pressed the F7 or F8 keys may trigger the capability to scroll backwards or forwards, respectively, within the screen. Additionally, receiving an indication that the user has pressed the F12 key may trigger the system to exit the user therefrom.

Returning to the “Grid/Reference Interest Rate Assignment” screen (an example of which being illustrated in FIG. 18), receipt of an indication that the user has pressed the enter key may trigger editing of the data that entered on this screen by the user, and allow the user to verify the entered data prior to approving it by pressing the F9 key. Receiving an indication that the user has pressed the F1 key may trigger display of the “Main Menu” screen (see FIG. 9). Receiving an indication that the user has pressed the F2 key may trigger display of a “Grid Structure” screen (see FIG. 14), which may be configured to allow a user to view all of the grids associated with a particular rate.

While the “Grid/Reference Interest Rate Assignment” screen is displayed, receipt of an indication that the user has pressed the F3 key may trigger display of a previously displayed screen. Receiving an indication that the user has pressed the F4 key may trigger the display of a reference rates screen (see FIG. 7) and may display a list of reference rates that the user can choose from when entering the interest rate ID. Receiving an indication that the user has pressed the F9 key may allow the user to approve the data after he has pressed the enter key and verified that the data is correct. The possibility of pressing the F3 key may not be displayed to the user until after the enter key is pressed. Receiving an indication that the user has pressed the F12 key may trigger the system to exit the user therefrom. Receiving an indication that the user has pressed the enter key after they have entered the option number they wish to select may trigger selection of the entered option number.

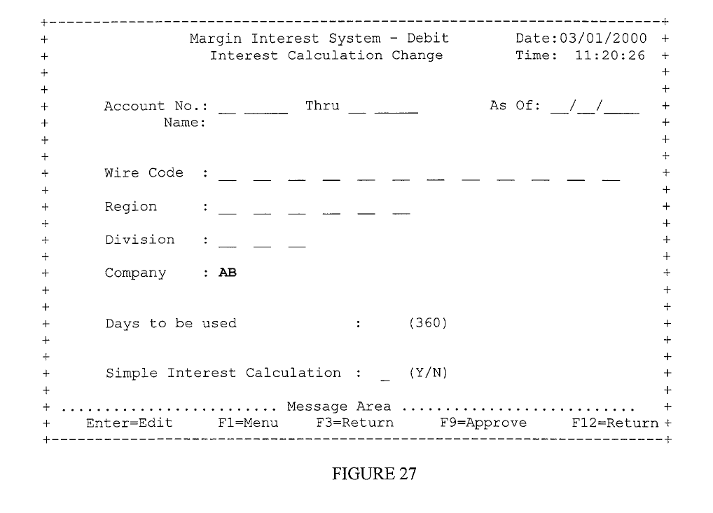

Display of an “Interest Calculation Change” screen (an example of which being illustrated in FIG. 27) may be triggered by a user selecting Option 2 of the “Administration Global/Custom Features” screen (see FIG. 24). The number of days in a year, used in the interest charge calculation may be modified on the “Interest Calculation Change” screen. The days selected can be made applicable to an account or to a range of accounts, as well as specified wire codes, regions, divisions or an entire company. The ability to change the days to be used for interest calculations may be limited, for example, changed only once per interest cycle.

An optional “as of” date may be entered on the screen by the user. This date may be either a prior or future date (potentially within the current cycle only). Entering a ‘Y’ in the “simple interest calculation” field may cause the interest to be booked as a non-compounded charge.

While the “Interest Calculation Change” screen is displayed, receipt of an indication that the user has pressed the enter key may trigger editing of the data that entered on this screen by the user, and allow the user to verify the entered data prior to approving it by pressing the F9 key. Receiving an indication that the user has pressed the F1 key may trigger display of the “Main Menu” screen (see FIG. 9). Receiving an indication that the user has pressed the F2 key may trigger display of a “Grid Structure” screen (see FIG. 14), which may be configured to allow a user to view all of the grids associated with a particular rate. Receiving an indication that the user has pressed the F3 key may trigger display of a previously displayed screen. Receiving an indication that the user has pressed the F9 key may allow the user to approve the data after he has pressed the enter key and verified that the data is correct. The possibility of pressing the F3 key may not be displayed to the user until after the enter key is pressed. Receiving an indication that the user has pressed the F12 key may trigger the system to exit the user therefrom.

It should be appreciated that preferred interest rates, with or without changes to a corresponding grid, may need to be approved before they become effective. The effective date of an interest rate change may default to a current date on final approval. If any item is not being approved, a reason code indicating the reason for disapproval may be entered into, for example, a “Reason For Disapproval” screen (an example of which being illustrated in FIG. 25) on return from the “Preferred Interest Rates” screen automatically.

Returning to the “Approve Preferred Interest Rates” screen (FIG. 23) functionality, while that screen is displayed, receipt of an indication that the user has pressed the enter key may trigger editing of any data that has been previously entered. Similarly, receiving an indication that the user has pressed the F1 key may trigger display of the “Main Menu” screen (see FIG. 9). Alternatively, receiving an indication that the user has pressed the F2 key after entering an ‘S’ next to the desired rate, may trigger display of the “Preferred Interest Rates” screen to review the details for the request. Further, receiving an indication that the user has pressed the F3 key may trigger display of a previously displayed screen. Receiving an indication that the user has pressed the F7 or F8 keys may enable the capability to scroll backwards or forwards, respectively, within the screen. Receiving an indication that the user has pressed the F9 key may trigger display of the “Reasons For Disapproval” screen (an example of which being displayed in FIG. 25), which may display a list of all active reasons for disapproval. Finally, receiving an indication that the user has pressed the F12 key may trigger the system to exit the user therefrom.

The “Reasons For Disapproval” screen (see FIG. 25) may display reasons and associated codes to signify why an interest rate change is not being approved. An initial set of reasons and codes may be provided the by administration users. While the “Reasons for Disapproval” screen is displayed, receipt of an indication that the user has pressed the enter key may edit any data that was entered on the screen, and give the user a chance to verify it before being approved. Similarly, receiving an indication that the user has pressed the F1 key may trigger display of the “Main Menu” screen (see FIG. 9). Receiving an indication that the user has pressed the F3 key may trigger display of a previously displayed screen. Alternatively, receiving an indication that the user has pressed the F7 or F8 keys may trigger the capability to scroll backwards or forwards, respectively, on the screen. Receiving an indication that the user has pressed the F9 key may allow the user to approve any changes previously made. Finally, receiving an indication that the user has pressed the F12 key may trigger the system to exit the user therefrom.

Returning to the functionality associated with the “Main Menu” screen (see FIG. 9), selection of the fifth and sixth options (Option 5: Approve Preferred Interest Rates and Option 6: Administration) may only be offered to authorized users. Selection of the fifth option may only be allowed by branch administration. Therefore, the fifth option may not even be displayed as an option on this menu, unless the user that is logged on has the appropriate authorization level. Selection of the fifth option may trigger display to the user of an “Administrative Functions Menu” screen (see FIG. 16), which may offer a variety of administrative functions, such as modifying reference rates, loan approval, adding or modifying account families, updating the family of blocked accounts, calculation of broker payment, etc.

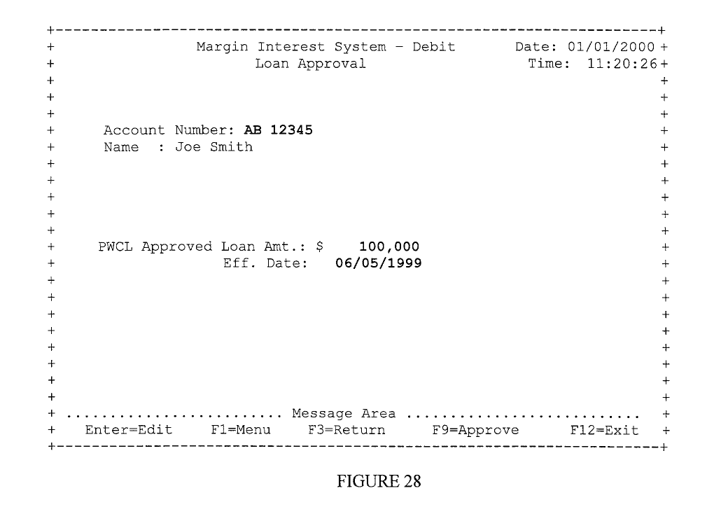

The “Administrative Functions Menu” screen allows the user to alter the operation of the system. Access to this screen may require that the user have a specific, predetermined security level. On the “Administrative Functions Menu” screen, a user may be allowed to select from various options associated with administration of system and screen functions. For example, selection of Option 1 may allow users to enter new rates daily on the “Reference Interest Rates” screen (see FIG. 7). Selection of Option 2 may allow users to set the maximum loan approval amounts for an account on the “Loan Approval” screen (an example of which being illustrated in FIG. 28). Selection of Option 3 may allow users to change global or custom features from an “Administration-Global/Custom Features Menu” screen (see FIG. 24) as explained herein.

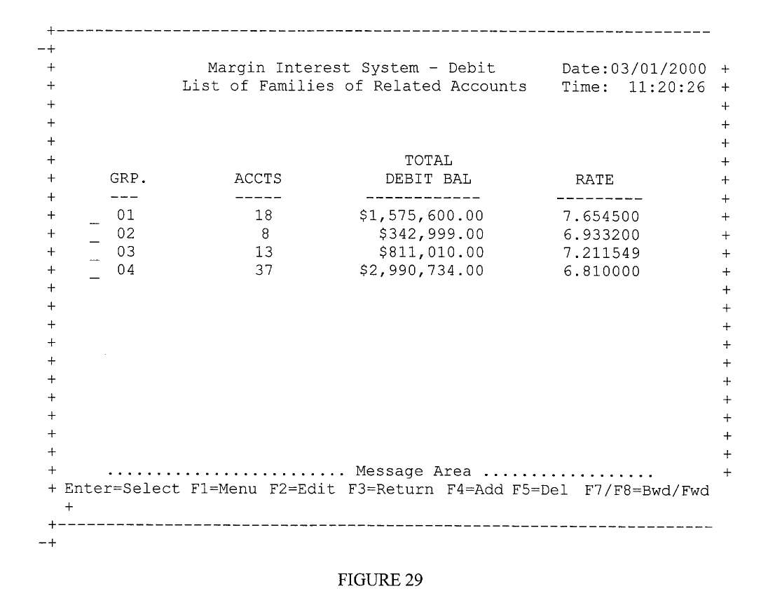

Selection of Option 4 may trigger display of a “List of Families of Related Accounts” screen (an example of which being illustrated in FIG. 29). This screen may display a list of families of related accounts Potentially, only those groups, which contain at least one account that belongs to the branch that is logged on, will be displayed. The same may be true at region or division levels.

While the “List of Families of Related Accounts” screen is displayed, receipt of an indication that the user has pressed the enter key after selecting a particular group may trigger display of a “Family of Related Accounts” screen (see FIG. 17). Receiving an indication that the user has pressed the F1 key may trigger display of the “Main Menu” screen (see FIG. 9). Receiving an indication that the user has pressed the F2 key may allow the user to edit the family of accounts. Receiving an indication that the user has pressed the F3 key may return the user to a previously displayed screen. Receiving an indication that the user has pressed the F4 key may allow the user to setup a new family of accounts.

Receiving an indication that the user has pressed the F5 key may trigger display of a user message, e.g., “Are you sure you want to delete this entire group?_(Y/N)”. If the user enters “Y” and presses the enter key, the relationship between all accounts in the group may be deleted. Receiving an indication that the user has pressed the F7 or F8 keys may trigger the scrolling backwards or forwards, respectively, of the user screen contents, if necessary. Receiving an indication that the user has pressed the F12 key main trigger the system to exit the user therefrom.

Display of the “Family of Related Accounts” may also be triggered, for example, by receiving an indication that the user has pressed the F3 key when viewing the “Debit Account Information” screen (see FIG. 12). The “Family of Related Accounts” screen may display the family of accounts related to the account on the “Debit Account Information” screen.

A user selecting Option 6 of the “Administrative Functions Menu” screen (see FIG. 16) may display a group of blocked accounts (e.g., a listing of client accounts that should not be charged margin interest). Receiving an indication that the user has pressed the enter key after selecting from the “List of Families of Related Accounts” screen (see FIG. 29) may trigger display of the related accounts. Triggering display of the “Family of Related Accounts” screen from the “Debit Account Information” screen may trigger display of all of the accounts related to a particular account in question. This account in question may be displayed at the top of the “Family of Related Accounts” screen. Accounts in the group displayed on the “Family of Related Accounts” screen may be deleted by the user placing “D” next to the account. Accounts may be added to the group by the user adding new accounts on an empty screen displayed after the system receives indication that the user has pressed the F6 key. Groups may be added by entering account numbers on the empty screen after the system receives an indication that the user has pressed the F4 key. Group numbers for new group may be assigned automatically after the system receives an indication that the user has pressed the F4 key. Groups may be deleted in response to receiving an indication that the user has pressed the F9 key after the user has requested to delete the group by pressing the F5 key. An account may be considered to be a part of the group from the beginning of the interest period in which it was added and the group balance may be used to calculate the interest charges from the first day of the period.

While the “Family of Related Accounts” screen is displayed, receipt of an indication that the user has pressed the enter key may trigger editing of all changes made by the user and allow the user to verify the data before approving it by pressing the F9 key. Receiving an indication that the user has pressed the F1 key may trigger display of the “Main Menu” screen (see FIG. 9). Receiving an indication that the user has pressed the F2 key may trigger display of the “List of Families of Related Accounts” screen (see FIG. 29), where the user may view all families of related accounts. Receiving an indication that the user has pressed the F3 key may trigger display of a previously displayed screen. Receiving an indication that the user has pressed the F4 key may allow the user to setup a new family of accounts. Receiving an indication that the user has pressed the F5 key may allow the user to delete group(s). Receiving an indication that the user has pressed the F6 key may allow the user to add an individual account to the group. Receiving an indication that the user has pressed the F7 or F8 key may trigger the ability for the user to scroll backwards or forwards, respectively, within the screen, if necessary. Receiving an indication that the user has pressed the F9 key may trigger the ability for the user to approve any changes he has submitted. The option of pressing the F9 key may potentially only be displayed to the user after the user has pressed the enter key and has verified his changes or request to delete. Changes may be applied to the data in the system after the F9 key has been pressed. Receiving an indication that the user has pressed the F12 key may trigger the system to exit the user therefrom.

Returning to the “Administrative Functions Menu” (see FIG. 16) functionality, selection of Option 5 allows the setting of broker compensation rates for an account, account range, company, or advice link share CPA(e.g., a client referred to the Company by Certified Public Accounts), by displaying the “Broker Compensation” screen (see FIG. 15) to the user.

Selection of Option 6 may trigger display of a group of blocked accounts, on a “Family of Related Accounts” screen (see FIG. 17). Someone with the proper authority may be allowed to add or delete accounts from this group.

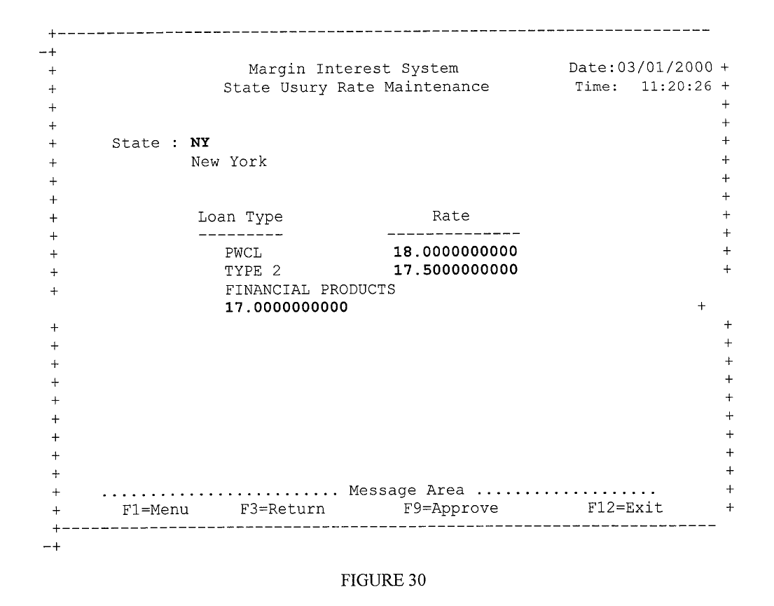

Selection of Option 7 may allow maintenance of the usury rates by state and by loan type by triggering display of a “State Usury Rate Maintenance” screen (an example of this screen is illustrated in FIG. 30). Display of this screen via the “Administrative Functions Menu” screen may allow the user to add, update, and delete the usury rates for all loan types (e.g., CREDIT LINE, TYPE 2, FINANCIAL PRODUCTS, etc.) by state. The rates may be applied by state of residence of the account holder. A two-character state code at the top may be overtyped to display the rates for different states. Rates for the state may be deleted by a user typing over them with spaces.

While the “State Usury Rate Maintenance” screen is displayed, receipt of an indication that the user has pressed the enter key may trigger editing all the changes previously submitted by the user and allow the user to verify the data before approving it by pressing the F9 key. Receiving an indication that the user has pressed the F1 key may trigger display of the “Main Menu” screen (illustrated in FIG. 9). Receiving an indication that the user has pressed the F3 key may return to a previously displayed screen. Receiving an indication that the user has pressed the F9 key may allow the user to approve his previously submitted changes. The option to press the F9 key may only be displayed after the user has pressed the enter key and has verified his changes. Changes may be applied to the database after the F9 key has been pressed. Receiving an indication that the user has pressed the F12 key may trigger the system to exit the user therefrom.

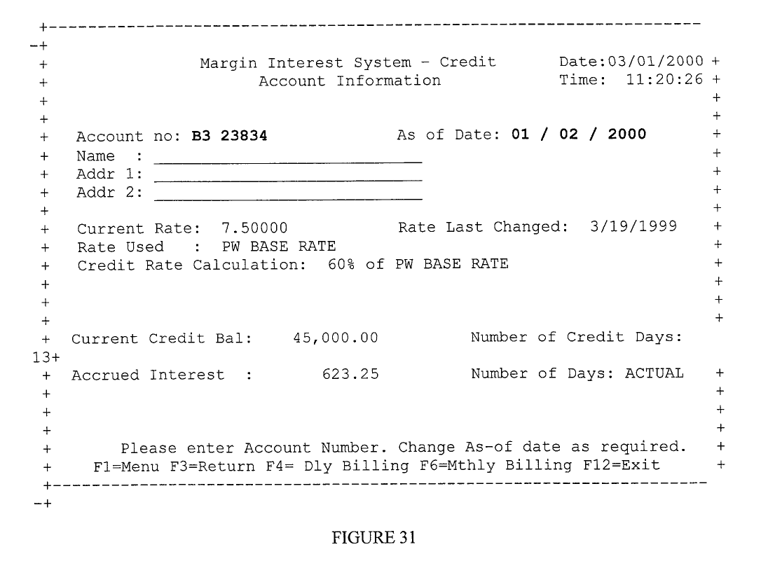

Turning to the credit functionality associated with the “Main Menu” (see FIG. 9), selection of option A may trigger display of a “Credit Account Information” screen (an example of which being illustrated in FIG. 31), which may display interest data, such as rate, approved loan amount, debit balance., etc., at the account level. On the “Credit Account Information” screen, the account prefix (e.g., the office code) may be populated by the program from the user profile. Only users with the appropriate privileges may be able to change this field. The account number may be required. Optionally, an “as of” date may be entered on this screen. If entered, this date may need to be prior to the current date. The “as of”, if not entered, may default to the current date. An address related to the account may be retrieved for display. Also displayed, may be the reference interest rate and/or preferred interest rate, the date that the reference interest rate was last changed, etc. In addition, another “as of” date may be entered for projecting the interest and total amounts. If entered, this date may need to be greater than the current date.

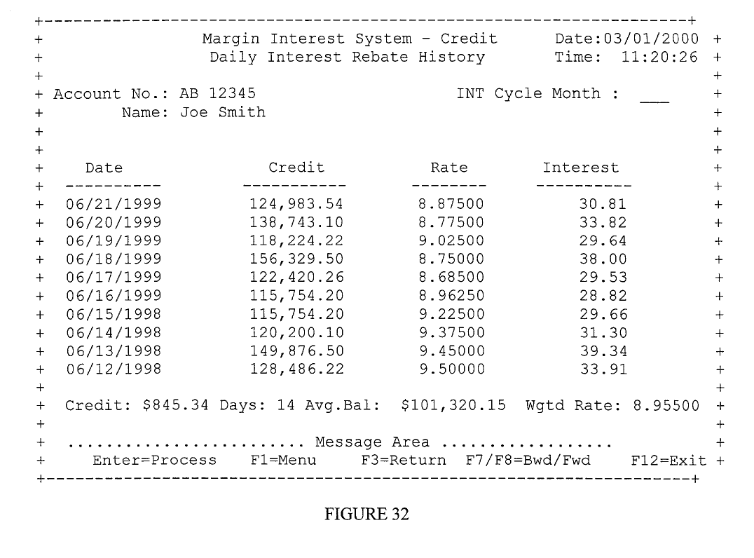

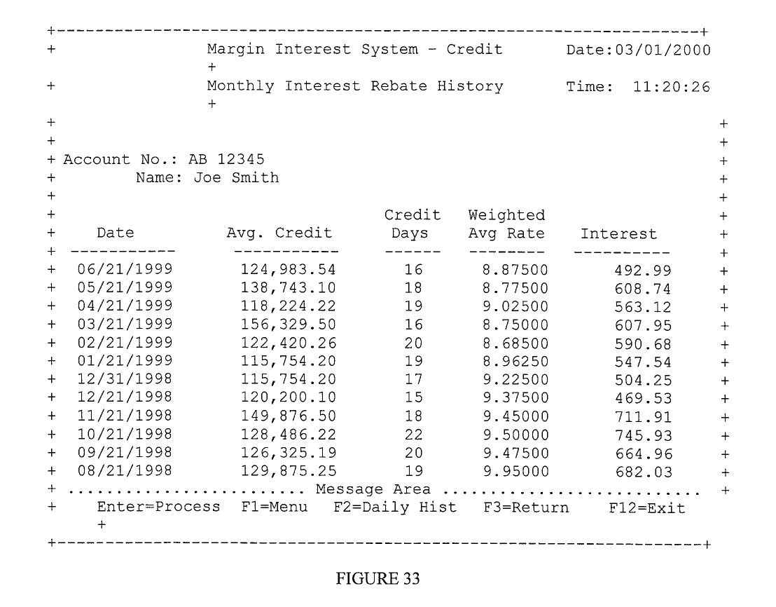

While the “Credit Account Information” screen is displayed, receipt of an indication that the user has pressed the enter key may process any data that was entered. If a new account number was entered, data for that account may be displayed. Receiving an indication that the user has pressed the F1 key may bring you back to the “Main Menu” screen (see FIG. 9). Receiving an indication that the user has pressed the F3 key may trigger display of a previously displayed screen. Receiving an indication that the user has pressed the F4 key may display the “Daily Interest Rebate History” screen (an example of which being illustrated in FIG. 32). Receiving an indication that the user has pressed the F6 key may display the “Monthly Interest Rebate History” screen (an example of which being illustrated in FIG. 33). Receiving an indication that the user has pressed the F12 key may trigger the system to exit the user therefrom.

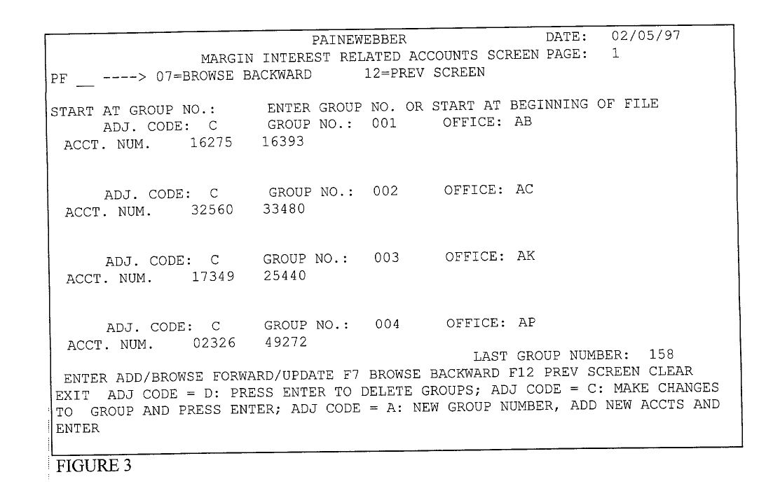

The functionality associated with the “Credit Account Information” screen (see FIG. 3 1) may provide for calculation of “What If” scenarios for the purposes of determining payoff. The “Credit Account Information” screen displays client information such as name and address, account balance, the number of days a credit balance was held in the current period, the credit rate used for calculation, and the accrued interest, for those accounts in branches which are entitled to receive credit interest. The screen provides “as of” date processing for projection forward or historical reference to the state of the account during a previous cycle.

Returning to the “Monthly Interest Rebate History” screen (see FIG. 33) functionality, that screen may be triggered by receiving an indication that the user has pressed the F4 key from the “Credit Account Information” screen (see FIG. 31). The “Monthly Interest Rebate History” screen may display the average credit and average interest rate as of the closing dates for a period of time, for example, twelve months on a rolling basis. This screen may also show the monthly billing history for a particular account, for the past twelve months.

While the “Monthly Interest Rebate History” screen is displayed, receipt of an indication that the user has pressed the enter key after entering a new account number at the top of the screen, may display the data for that new account number. Receiving an indication that the user has pressed the F1 key may trigger display of the “Main Menu” screen (see FIG. 9). Receiving an indication that the user has pressed the F2 key may trigger display of the “Daily Interest Rebate History” screen (see FIG. 32) for the same account. Receiving an indication that the user has pressed the F3 key may trigger display of a previously displayed screen. Receiving an indication that the user has pressed the F12 key may trigger the system to exit the user therefrom.

The “Daily Interest Rebate History” screen (see FIG. 32) may include information available for the current month and the eleven prior months. The default display may be for the previous month. While the “Daily Interest Rebate History” screen is displayed, receiving an indication that the user has pressed the enter key after entering a new account number or different interest cycle may process the request and give the user the desired data. Receiving an indication that the user has pressed the F1 key may trigger display of the “Main Menu” screen (see FIG. 9). Receiving an indication that the user has pressed the F3 key may trigger display of a previously displayed screen. Receiving an indication that the user has pressed the F7 or F8 keys may enable the capability to scroll backwards or forwards, respectively, within the screen. Receiving an indication that the user has pressed the F12 key may trigger the system to exit the user therefrom.

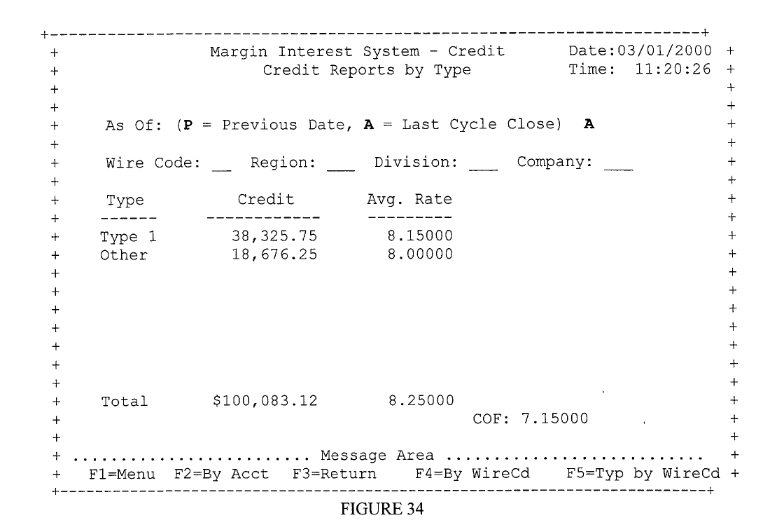

Returning to the credit functionality associated with the “Main Menu” (see FIG. 9), selection of Option B may trigger display of a “Credit Reports By Type” screen (see FIG. 34), which may summarize data for all types within a wire code, region, or division. Other reports may also be available using this “Credit Reports By Type” screen. The “Credit Reports By Type” screen may display credit reports by type for a particular wire code, region, division, or company; as of the previous night's close or as of the last cycle close date. This report screen may show a summary line for each type within a wire code, region, division or company.

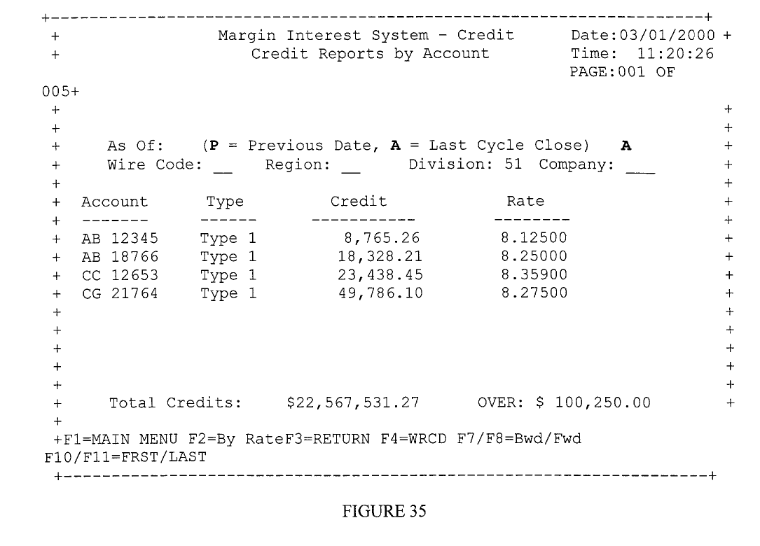

While the “Credit Reports By Type” screen is displayed, receipt of an indication that the user has pressed the enter key may process the request that was entered and display the appropriate data. Receiving an indication that the user has pressed the F1 key may trigger display of the “Main Menu” screen (see FIG. 9). Receiving an indication that the user has pressed the F2 key and entering a particular wire code, region, division, or company may bring the user to the “Credit Reports By Account” screen (an example of which being illustrated in FIG. 35), which may display information for the largest credit balance accounts, for the selected wire code, region, division, or company.

The “Credit Reports By Account” screen may display the data at the account level for the selected wire code, region, etc., as of the previous night's close or as of the close of the previous interest cycle. The appropriate information may be displayed based on the requested data from previous screen. While the “Credit Reports By Account” screen is displayed, receipt of an indication that the user has pressed the enter key may process the request and display the requested information. Receiving an indication that the user has pressed the F1 key, although not shown on the screen (for lack of room) may trigger display of the “Main Menu” screen (see FIG. 9). Receiving an indication that the user has pressed the F2 key may trigger display of the same report in ascending order by interest rate or by account. The total credits listed at the bottom of the screen may be the total for all the pages in the report (not for just the data that is being displayed on the current report). Receiving an indication that the user has pressed the F3 key may trigger display of a previously displayed screen. Thus, if a user selects the credit report type from a previously displayed screen, it may be stored until the user presses the F3 key. Subsequently, the user can select the credit report type. Receiving an indication that the user has pressed the F3 key may trigger display of a previously displayed screen.

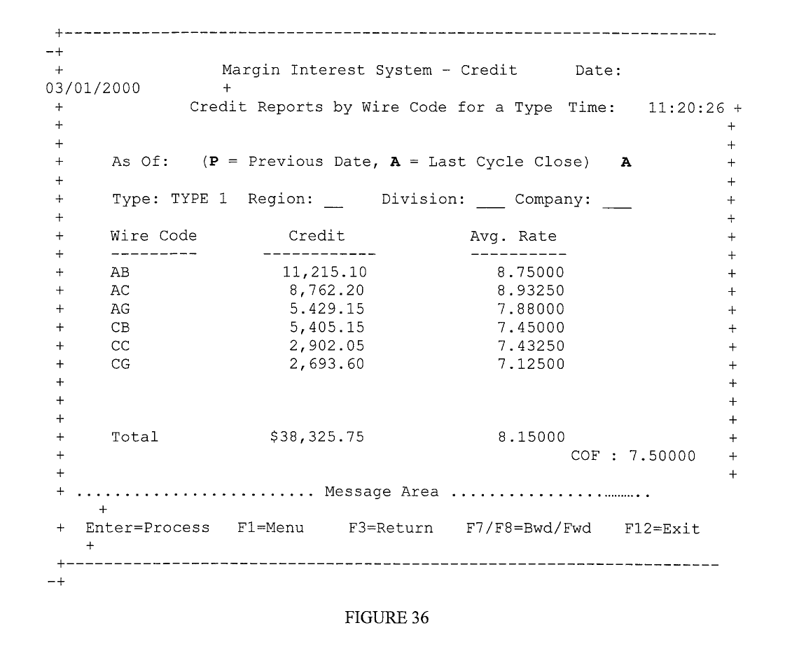

Receiving an indication that the user has pressed the F4 key and entering a particular region, division, or company may trigger display of the “Credit Report By Wire Code For a Type” screen (an example of which being illustrated in FIG. 36), which may display information at the wire code level, for all wire codes within the selected region, division, or company. Receiving an indication that the user has pressed the F7 or F8 keys enable the capability to scroll backwards or forwards, respectively, through the report. Receiving an indication that the user has pressed the F10 or F11 display the first or last page of the report, respectively. Receiving an indication that the user has pressed the F12 key may trigger the system to exit the user therefrom.

This “Credit Reports By Wire Code For a Type” screen may display credit amounts at a branch level, for a particular type and a particular region, division or company, which were selected on a previously displayed screen. A user can overtype the type field to display a specific type code, or “all” to display all type-codes. The user can also enter a different region, division, or company.

While displaying the “Credit Reports By Wire Code For a Type” screen, receipt of an indication that the user has pressed the enter key after typing over the type or entering a new region, division, or company may process that request. Receiving an indication that the user has pressed the F1 key may trigger display of the “Main Menu” screen (see FIG. 9). Receiving an indication that the user has pressed the F3 key may trigger display of a previously displayed screen. Receiving an indication that the user has pressed the F7 or F8 keys may enable scrolling backwards and forwards, respectively, within the screen. Receiving an indication that the user has pressed the F12 key may trigger the system to exit the user therefrom.

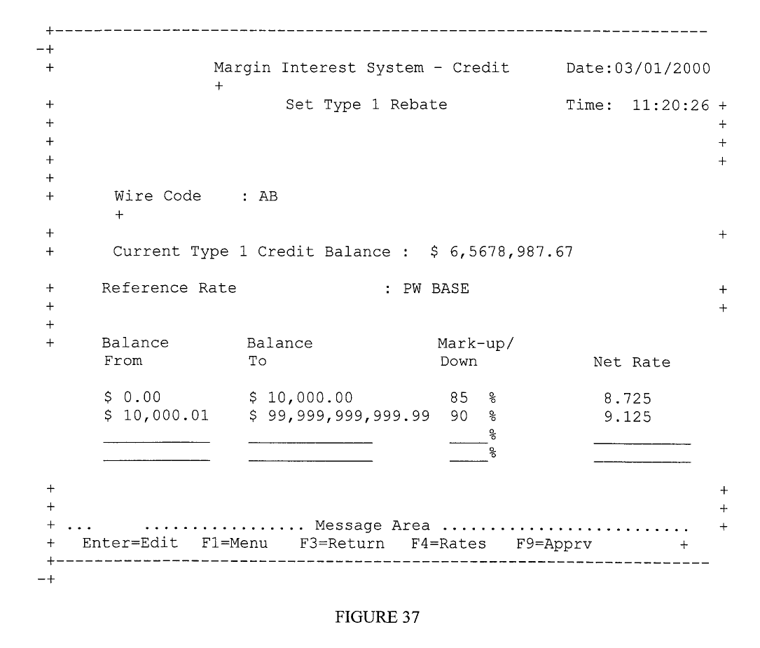

Returning to the credit functionality of the “Main Menu” screen (see FIG. 9), selection of Option C may trigger display of a “Set Type 1 Rebate” screen (an example of which being illustrated in FIG. 37), which may allow an authorized user to setup credit interest rates for an account or a range of accounts.

The “Set Type 1 Rebate” screen may enable authorized users to set up a type 1 rebate for an account. A type 1 rebate is a payment of interest to a client for the client holding cash balances at a company associated with the interest determination system. This option's use may be limited to users with the proper authority. An optional “as of” date may be entered. If entered, this date may need to be prior to the current date.

While the “Set Type 1 Rebate” screen is displayed, receipt of an indication that the user has pressed the enter key may trigger editing and validation of data previously typed into the screen, it may not enter the rebate into the system. Receiving an indication that the user has pressed the F1 key may trigger display of the “Main Menu” screen (see FIG. 9). Receiving an indication that the user has pressed the F3 key may trigger display of a previously displayed screen. Receiving an indication that the user has pressed the F4 key may trigger display of the “Reference Interest Rates” screen (see FIG. 7), which may display a list of the reference interest rates currently in use. Receiving an indication that the user has pressed the F9 key may trigger the capability for the user to approve the data after he has pressed the enter key and verified that the data is correct. The option of pressing the F9 key may not be displayed until the enter key has been pressed. Receiving an indication that the user has pressed the F12 key may trigger the system to exit the user therefrom.

While the invention has been described with reference to the certain illustrated embodiments, the words which have been used herein are words of description, rather than words or limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

What is claimed is:

1. An interest determination system that performs daily calculation of account interest with a single monthly processing of client charges, the system comprising:
at least one processor configured to calculate daily account interest based on interest rate data and an account balance for each particular day in response to instructions provided by at least one user;
at least one memory device coupled to the processor and configured to store and provide access to instructions dictating at least some part of operation of the system;
at least one system interface coupled to the processor and configured to receive data for use in calculating account interest and transmit calculated account interest data to other systems; and
at least one user interface coupled to the processor, including at least one graphical user interface and configured to receive the instructions from the at least one user and output interest rate data and account interest data to the at least one user;
wherein the at least one processor is configured to control operation control at least some part of operation of the at least one system interface and the at least one user interface based on instructions stored in the at least one memory device.

2. The system of claim 1, wherein the at least one system interface includes data feeds providing at least one of financial data, account data, reference rate data used by the system to calculate account interest.

3. The system of claim 1, wherein the system calculates margin interest associated with at least one account maintained in association with buying stocks.

4. The system of claim 1, wherein the system enables a user to chose a reference interest rate based upon which the interest determination system calculates account interest.

5. The method of claim 4, wherein the choice of reference interest rates includes a prime interest rate, broker call interest rate, a base lending interest rate, LIBOR-30 day interest rate and LIBOR-60 day interest rate.

6. The system of claim 1, wherein the at least one memory device is also configured to store data indicating account interest calculations performed by the interest determination system.

7. The system of claim 1, wherein the at least one processor and the at least one memory device are implemented via one or more servers coupled to a network that allows the at least one user interface to communicate with the at least one processor.

8. The system of claim 1, wherein the at least one user interface includes at least one of hardware and software for cooperating with a terminal display, a keyboard and mouse, a speaker and a microphone.

9. The system of claim 1, the at least one graphical user interface includes a Main Menu screen configured to output data to at least one user regarding available system functionality and receive input data from at least one user indicating instructions provided by the user.

10. The system of claim 1, wherein the at least one graphical user interface includes at least one of a:
a Reference Interest Rates screen configured to display a list of available reference interest rates and receive indication of a selection of at least one available reference rate;
a Rate Calendar screen configured to receive input data from at least one user for updating available reference interest rates;
a Daily Billing History screen configured to display a history of daily rolling account balances for a plurality of previous interest cycles, which includes a current interest cycle;
a Monthly Billing History screen configured to display, by account, a plurality of rolling months of monthly interest charges/credits; and
a Family of Related Accounts screen configured to display a family of related accounts for a particular account if a selected account is part of a family of accounts.

11. The system of claim 1, wherein the at least one graphical user interface includes at least one of a:
a Debit Account Information screen configured to display account data, including at least one of interest rate data, approved loan amount data and debit balance data and enable at least one user to enter an account number and view data related to that account; and
a Credit Account Information screen configured to configured to display interest rate data, approved loan amount data, and debit balance data and enable at least one user to enter an account number and view data related to that account.

12. The system of claim 1, wherein the at least one graphical user interface includes at least one of a Sign On screen configured to control access to the interest determination system to only those users with authorization to utilize the system using user identification data and password data.

13. The system of claim 1, wherein the at least one graphical user interface includes a Broker Compensation screen configured to allow at least one user to calculate and adjust compensation associated with at least one broker.

14. The system of claim 1, wherein the at least one graphical user interface includes at least one of:
a Grid Structure screen configured to display at least one grid associated with at least reference interest rate selected in response to data input by at least one user;
a Grid/Reference Interest Rate Assignment screen enabling at least one user to establish or adjust a default interest rate for debit interest; and
a Preferred Interest Rates screen configured to enable at least one user to establish or modify preferred interest rates for an account or range of accounts.

15. The system of claim 1, wherein the at least one graphical user interface includes at least one of:
a Loan Reports By Type screen configured to display loan reports by type for a particular wire code, region, division, or company indicated by data input by at least one user into at least one screen included in the at least one user interface;
a Loan Reports By Account screen configured to display data associated with largest debit balance accounts over an entered limit, for a selected wire code, region, division, or company indicated by data input by at least one user into at least one screen included in the at least one user interface;
a Loan Reports By Wire Code screen configured to display data for all wire codes within a selected region, division, or company indicated by data input by at least one user into at least one screen included in the at least one user interface; and
a Loan Reports By Wire Code for a Type screen configured to display data for a selected type for all wire codes within a selected region, division, or company indicated by data input by at least one user into at least one screen included in the at least one user interface;

16. The system of claim 1, wherein the at least one graphical user interface includes an Administrative Functions Menu screen configured to enable a user to at least one of modify a reference interest rate, approve a loan, add or modify an account family, update a family of blocked accounts, and calculate broker compensation.

17. The system of claim 1, wherein the at least one graphical user interface includes a State Usury Rate Maintenance screen configured to process interest rate adjustments to verify that the adjustments are in compliance with usury regulations.

18. The system of claim 1, wherein the at least one graphical user interface includes a Monthly Interest Rebate History screen configured to display average credit and average interest rate as of a closing date for a period of time on a rolling basis.

19. The system of claim 1, wherein the at least one graphical user interface includes at least one of:
a Credit Reports By Type screen configured to display credit report data associated with all types within a wire code, region, or division indicated by data input by at least one user into at least one screen included in the at least one user interface;
a Credit Reports By Account configured to display information for largest credit balance accounts for a selected wire code, region, division, or company indicated by data input by at least one user into at least one screen included in the at least one user interface; and
a Credit Report By Wire Code For a Type screen configured to display data for all wire codes within a selected region, division, or company indicated by data input by at least one user into at least one screen included in the at least one user interface.

20. The system of claim 1, wherein the at least one graphical user interface includes a Rebate screen configured to enable at least one user to establish or modify credit interest rates for an account or a range of accounts.
